(19) United States
(12) Patent Application Publication
(10) Pub. No.: US 2025/0326291 A1
(43) Pub. Date: Oct. 23, 2025

(54) SELECTABLE LOW RANGE SHIFT ARCHITECTURES FOR AN ELECTRIFIED TRANSFER CASE/INTEGRATED E-AXLE

(71) Applicant: Dana Automotive Systems Group, LLC, Maumee, OH (US)

(72) Inventors: Benjamin POWELL, Austin, TX (US); Eric M. ENGERMAN, Plymouth, MI (US); Jens SCHNEBELE, Petersburg, MI (US); Ryan D. NELMS, Weatherford, TX (US); Burke SMITH, Bruce Township, MI (US)

(21) Appl. No.: 19/187,771

(22) Filed: Apr. 23, 2025

Related U.S. Application Data
(60) Provisional application No. 63/637,774, filed on Apr. 23, 2024.

(51) Int. Cl. B60K 17/06; B60K 1/00; B60K 17/02; B60K 17/16; F16H 37/08; F16H 57/08; F16H 61/682; F16H 63/04

(52) U.S. Cl. CPC B60K 17/06; B60K 1/00; B60K 17/02; B60K 17/165; F16H 37/082; F16H 57/082; F16H 61/682; F16H 63/04; B60K 2001/001; F16H 2200/0021; F16H 2200/0034; F16H 2200/2007; F16H 2200/2094

(57) ABSTRACT

An electric drive axle with a two-speed gearbox and shifting system is described herein that advantageously reduces a size and volume of the electric drive axle for tight cross-car packaging in a constrained environment for integration of the gearbox with an electric machine, inverter, and differential. The gearbox includes higher and lower range planetary gear sets that are arranged coaxially with the electric machine. The higher and lower range planetary gear sets can be operated in a higher range mode, where mechanical power from an electric machine bypasses the lower range planetary gear set, and in a lower range mode, where mechanical power from the electric machine travels through the lower range planetary gear set and the higher range planetary gear set. The described configuration expands a functionality of the gearbox and increases the axle's capability with regard to operating range and driving environment.

### CROSS REFERENCE TO RELATED APPLICATIONS

The present application claims priority to U.S. Provisional Application No. 63/637,774, entitled “SELECTABLE LOW RANGE SHIFT ARCHITECTURES FOR AN ELECTRIFIED TRANSFER CASE/INTEGRATED E-AXLE”, and filed on Apr. 23, 2024. The entire contents of the above-listed application are hereby incorporated by reference for all purposes.

### TECHNICAL FIELD

The present description relates to a multi-speed gearbox of a vehicle.

### BACKGROUND AND SUMMARY

Existing vehicle subframe architectures may provide a package constrained environment for integration of a multi-speed gearbox with an electric motor, inverter, and differential. Tight cross-car packaging may be difficult to achieve with current designs for two-speed e-synchronous shifting architectures that can couple to an electric motor and/or differential.

In one example, the issue described above may be addressed by an electric drive axle of a vehicle, comprising an electric machine rotationally coupled to a gearbox, the gearbox comprising a higher range planetary gear set coupled to a lower range planetary gear set via a clutch; and an output gear designed to receive rotational input from at least one of the higher range planetary gear set and the lower range planetary gear set; wherein the clutch is configured to, in a lower range position, direct mechanical power through the higher range planetary gear set and the lower range planetary gear set; and in a higher range position, direct mechanical power to the higher range planetary gear set which bypasses the lower range planetary gear set.

### BRIEF DESCRIPTION OF THE FIGURES

FIG. 1 shows a schematic representation of a vehicle that includes a first example of an electric drive axle.

FIG. 2 shows a schematic representation of a second example of an electric drive axle.

FIGS. 3A-3B show power paths for different operating ranges of the electric drive axle, depicted in FIG. 1.

FIG. 3C shows a table that indicates the configuration of the gearbox clutch in the different operating ranges, shown in FIGS. 3A and 3B.

FIGS. 4A-4B show power paths for different operating ranges of the electric drive axle, depicted in FIG. 2.

FIG. 5 shows a method for controlling a gearbox system.

FIG. 6 shows a timing diagram of a use-case gearbox control strategy.

FIG. 7 shows a side view of an assembly that may house the use-case gearbox.

FIG. 8 shows a sectional view of the use-case gearbox including the two speed shift system that including the gear sets and clutches of a first embodiment.

FIG. 9 shows a sectional view of an area of the use-case gearbox including a use-case shift system of a use case clutch including a sleeve and a carrier of a first embodiment.

FIG. 10 shows a sectional view of an area of the use-case gearbox including a use-case shift system of a use case clutch including a sleeve and a carrier of a second embodiment.

FIG. 11A shows the use case shift system including the sleeve and the carrier of the second embodiment in a low range position.

FIG. 11B shows the use case shift system including the sleeve and the carrier of the second embodiment in a neutral position.

FIG. 11C shows the use case shift system including the sleeve and the carrier of the second embodiment in a high range position.

FIG. 12 shows a side view of a gear set and a complementary carrier of a first embodiment.

FIG. 13 shows a side view of the gear set and the complementary carrier of the first embodiment.

FIG. 14 shows a side view of a first detent insert of a first embodiment.

FIG. 15 shows a side view of a second detent insert of a second embodiment.

FIG. 16 shows a sectional view of a third detent insert housed in an opening in a sleeve.

FIG. 17 shows a side view of a first sleeve of a first embodiment.

FIG. 18 shows a side view of a second sleeve of a second embodiment.

FIG. 19 shows a force application diagram versus spring radius, including a plurality of data point plots and traces for different wire springs.

FIG. 20 shows a side view of an embodiment of a sleeve of a second embodiment.

FIG. 21 shows a sectional view of an embodiment of a sleeve of the second embodiment.

FIG. 22 shows a sectional view of an area of a use-case gear box and an actuator assembly of a first embodiment.

FIG. 23 shows a view an actuator assembly of a second embodiment.

FIG. 24 shows a sectional view of a first use-case clutch assembly and shift system including a sleeve and a carrier of a third embodiment.

FIG. 25 shows a sectional view of a second use-case clutch assembly and shift system including a sleeve and a carrier of a fourth embodiment. system that may be carrier piloted.

FIG. 26 shows a sectional view of an area of a use case gear box and an actuator assembly of a third embodiment.

### DETAILED DESCRIPTION

Various examples of an electric drive axle that includes a gearbox with a space efficient package that achieves higher and lower range operation using a clutch are described. The electric drive axle may include an electric motor and a clutch designed to direct power from the motor through one or both of a higher range planetary gear set and a lower range planetary gear set, in different operating configurations. Including the higher and lower range planetary gear sets may enable the axle's functionality to be expanded in a compact and space efficient manner, thereby increasing customer appeal.

A clutch system may enable shifting between the higher range planetary gear set and the lower range planetary gear set. When shifted to the higher range planetary gear set via the clutch system, higher range of torques may be output by the gearbox. When shifted to the lower range planetary gear set via the clutch system, a lower range of torques may be output by the gearbox. The clutch system may be a clutch assembly including a shift sleeve, a shifting arm, a first planetary carrier for a first set of planetary gears (e.g., planet gears), a second planetary carrier for a second set of planetary gears, and a first engagement component rotationally coupled to a sun gear. The shift sleeve and second planetary carrier may include the clutch components of the clutch assembly, where the clutch components form a clutch. The shift sleeve may include the engaging component of the clutch components. The second planetary carrier may include a second engagement component of the clutch components, where the engaging component may be shifted to engage with the engagement component, while the engagement component is fixed to the second planetary carrier. The first engagement component may also be a clutch component. The clutch of the clutch assembly may be a dog clutch, such that the engaging component and engagement components may include a plurality of complementary dog teeth.

The clutch assembly may be engaged in at least three ways, where each way enables a mode. The clutch may be engaged in a first way to enable a lower range mode. The clutch may be engaged in a second way to enable a neutral mode, where the gear sets may rotate freely and independently from one another. The clutch may be engaged in a third way such as to enable a higher range mode. For example, when a first set of dog teeth of the engaging component mesh with the dog teeth of the first engagement component, the clutch assembly may be engaged in the first way. When a second set of dog teeth of the engaging component mesh with the dog teeth of the second engagement component, the clutch assembly may be engaged in the third way. When neither the first nor second set of dog teeth of the engaging component mesh with the dog teeth of the first engagement component or second engagement component, the clutch assembly may be engaged in the second way.

In addition to the engagement components, the first planetary carrier may have a first sleeve to support the engagement sleeve, such that the engagement sleeve may slide along the first sleeve. The first sleeve may have a plurality of inserts that may be complementary to features of the shift sleeve. The inserts may be complementary to passages, such as through holes, of the first sleeve, where each of the passages may be complementary to an insert of the inserts. The passages may allow for to slide radially outward and mate with the complementary features of the shift sleeve. Each of the inserts may be pressed upon by a spring, such as a wire spring. The spring may apply force and press on each of the inserts in an outward direction from the centerline of the first sleeve, such as in a radial direction. The force from the spring may press each of the inserts outward through the complementary passages. When a complementary feature passes over and aligns with an insert and a complementary passage, the insert may extend upward from the complementary passage and mate with the complementary feature. When the inserts are mated with the complementary features, the inserts may prevent movements, such as sliding, of the shift sleeve. The inserts may become unmated and the shift sleeve may slide with deliberate force from the shift arm. The inserts may become unmated with complementary features when pressed downward relative to the centerline of the first sleeve via non complementary surfaces of the shift sleeve. The non-complementary surfaces may prevent the inserts from moving outward from the complementary passages. When unmated, the inserts may be pushed inward and into the complementary passages. The inserts may be detent inserts and may be referred alternatively throughout as detent inserts.

There may be a plurality of configurations of inserts. For a clutch assembly of the present disclosure there may be three embodiments of inserts, such as a plurality of first inserts, a plurality of second inserts, and a plurality of third inserts. There may also be two types of shift sleeves, each complementary and locked in place by different embodiments of inserts. For example, a first type of shift sleeve may have a plurality of first complementary features to mate with the first inserts. Likewise, second type of shift sleeve may have a plurality of second complementary features to mate with the second inserts.

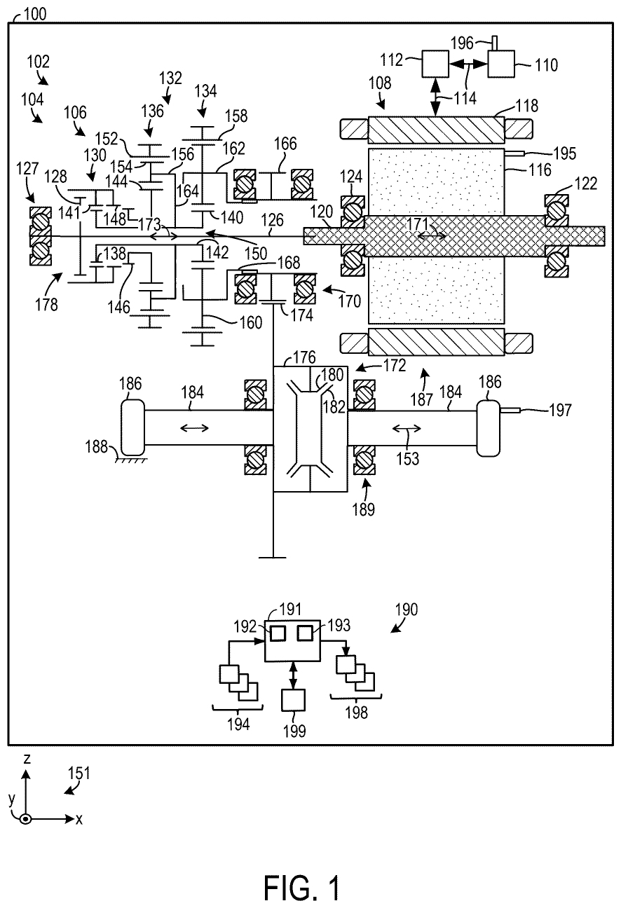

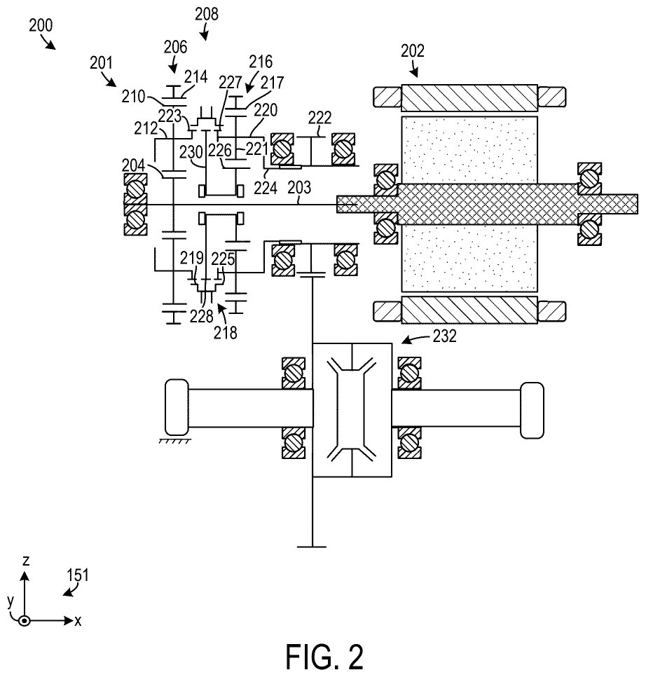

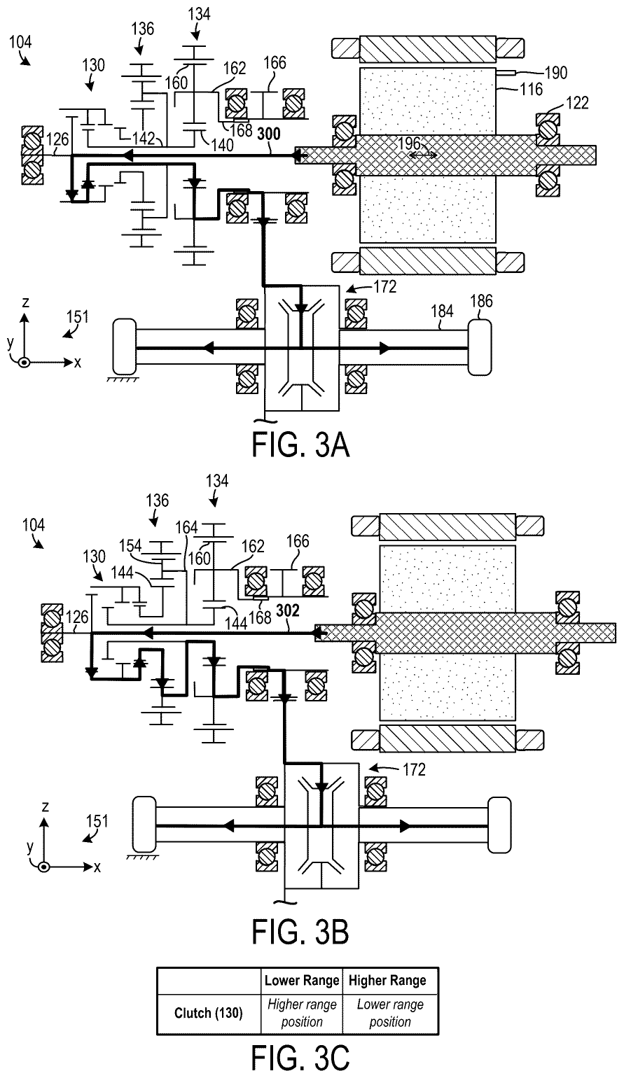

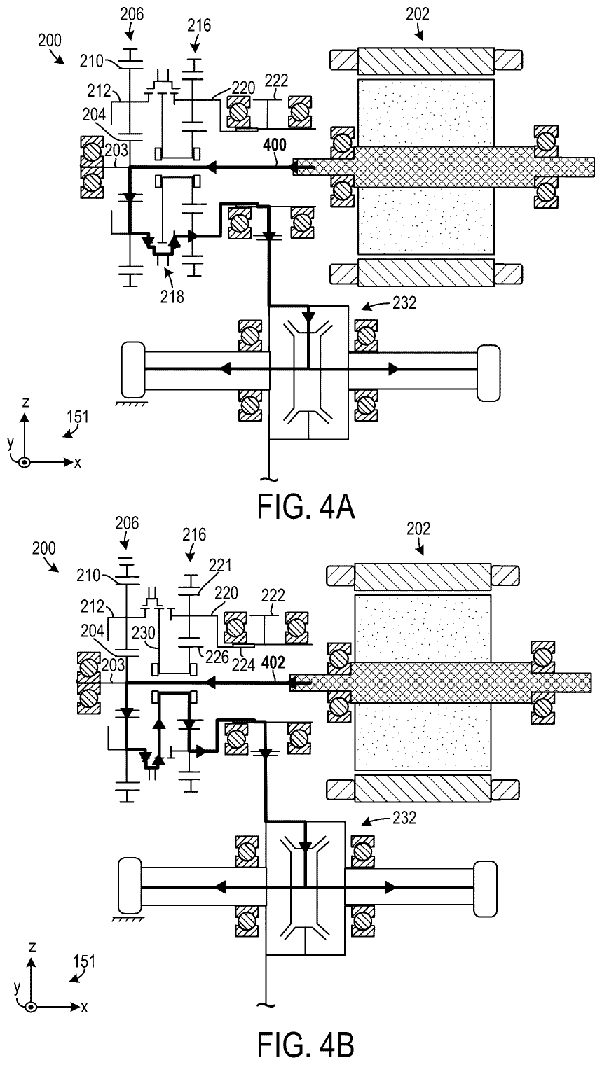

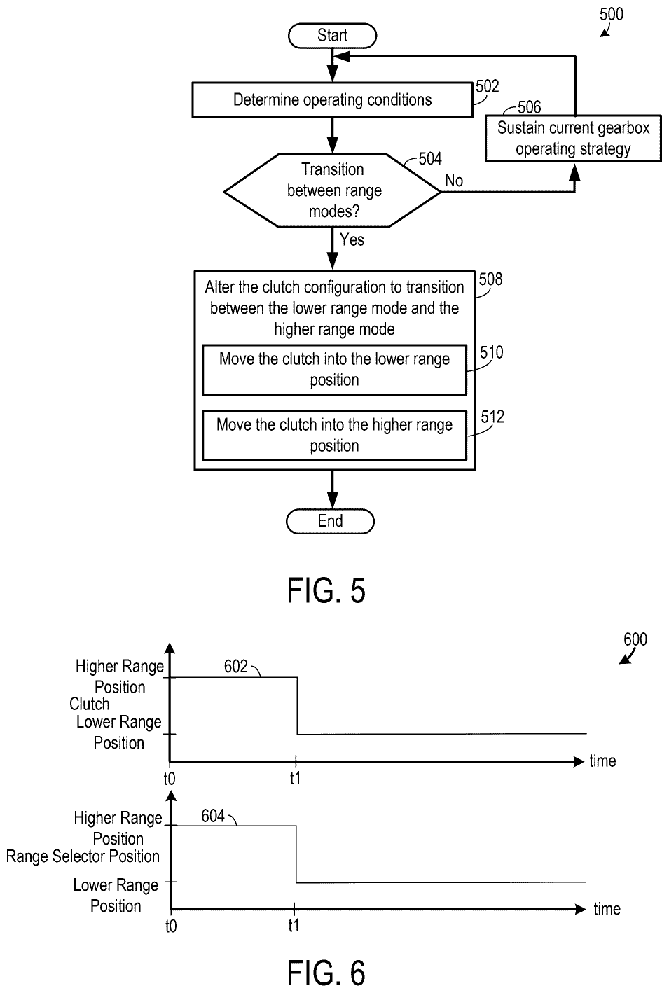

FIG. 1 schematically illustrates a vehicle with a first example of an electric drive axle with a higher and a lower range operating modes. FIG. 2 schematically illustrates a second example of an electric drive axle that again includes a higher and lower range operating modes. FIGS. 3A-3B illustrate the power paths, in the electric drive axle depicted in FIG. 1, in the higher range operating mode and the lower range operating mode, respectively, enabling the use of the vehicle in which the drive axle is deployed in a number of different operating environments. FIG. 3C depicts a chart corresponding to the configurations of the clutches in the different gears in the gearbox system. FIGS. 4A-4B illustrate the power paths, in the electric drive axle depicted in FIG. 2, in the higher range operating mode and the lower range operating mode, respectively. FIG. 5 shows a method for switching between range modes of the gearbox. FIG. 6 illustrates a timing diagram for a use-case gearbox operating strategy for transitioning between a higher range mode and a lower range mode.

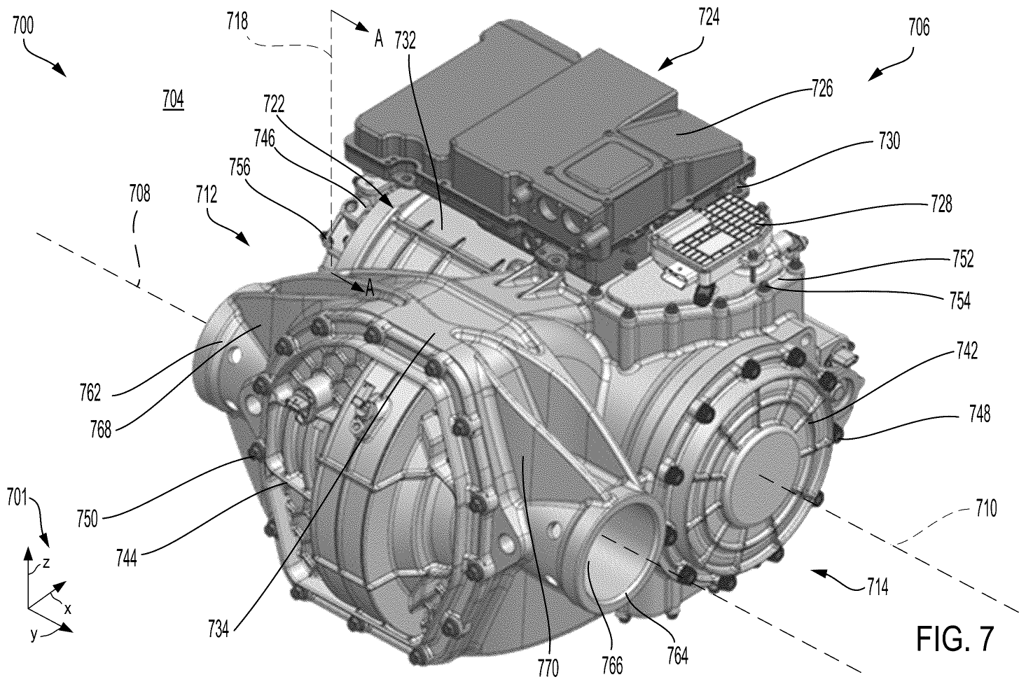

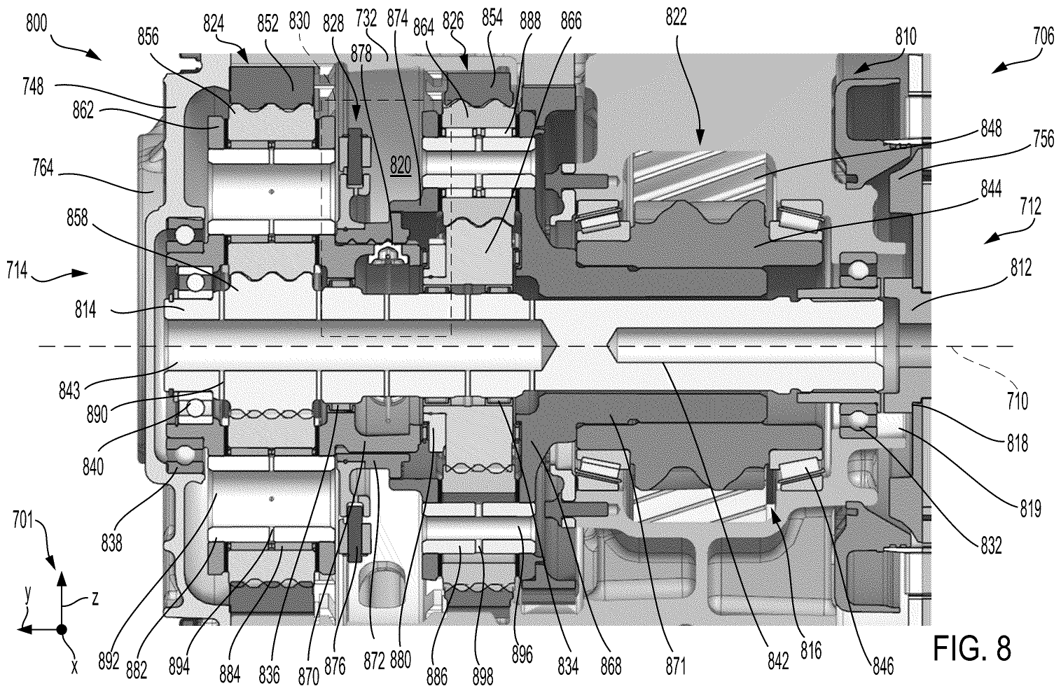

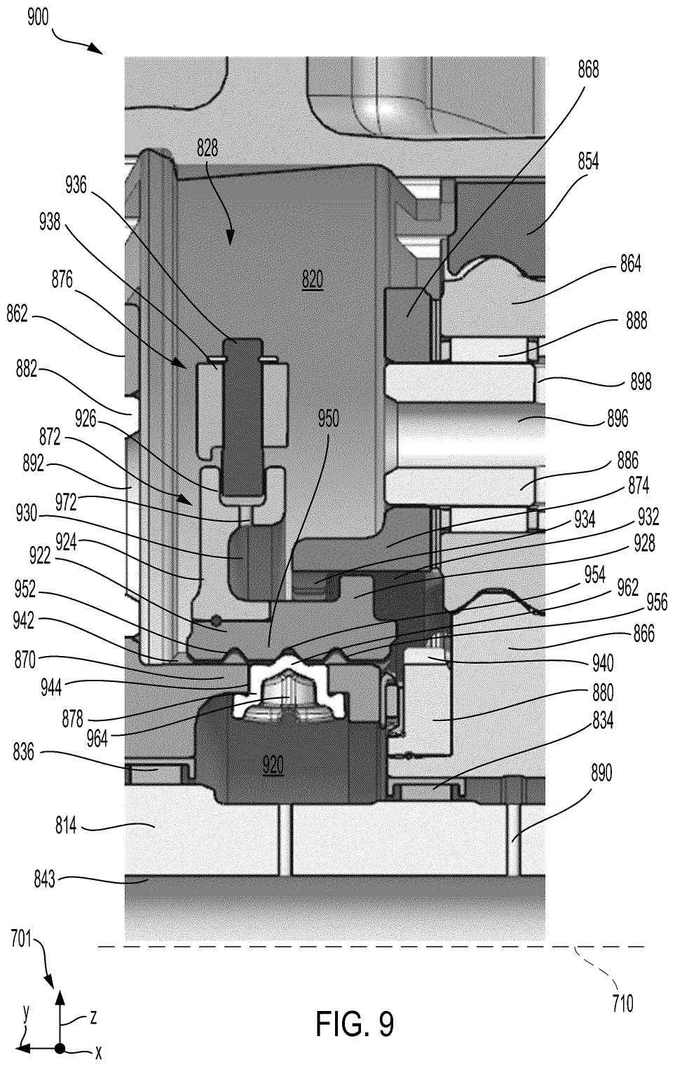

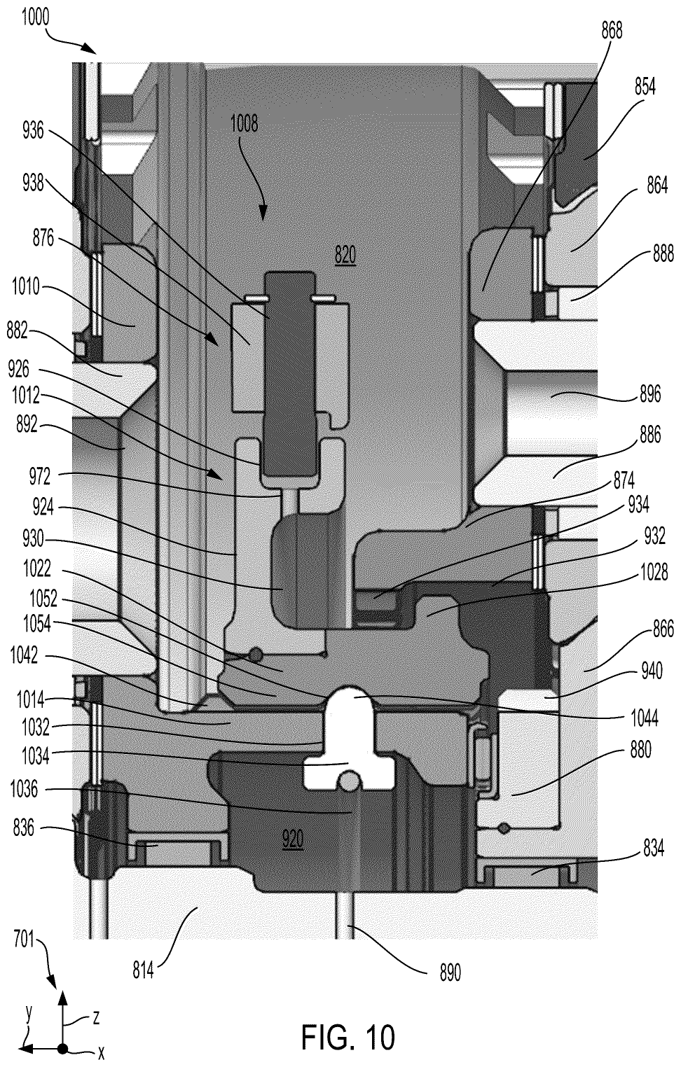

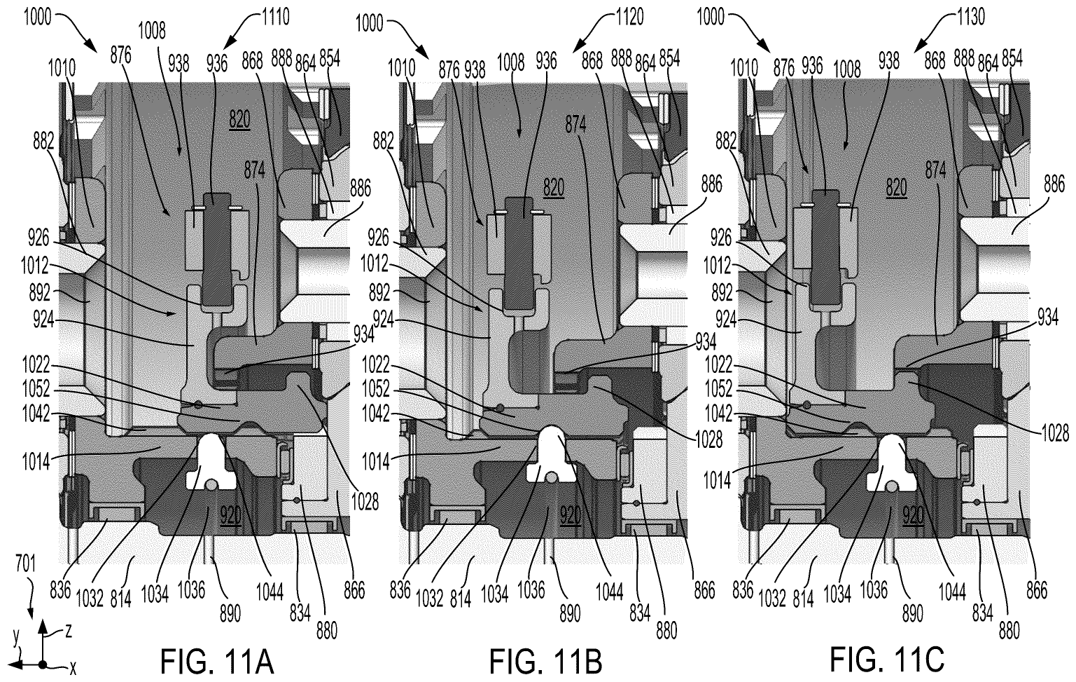

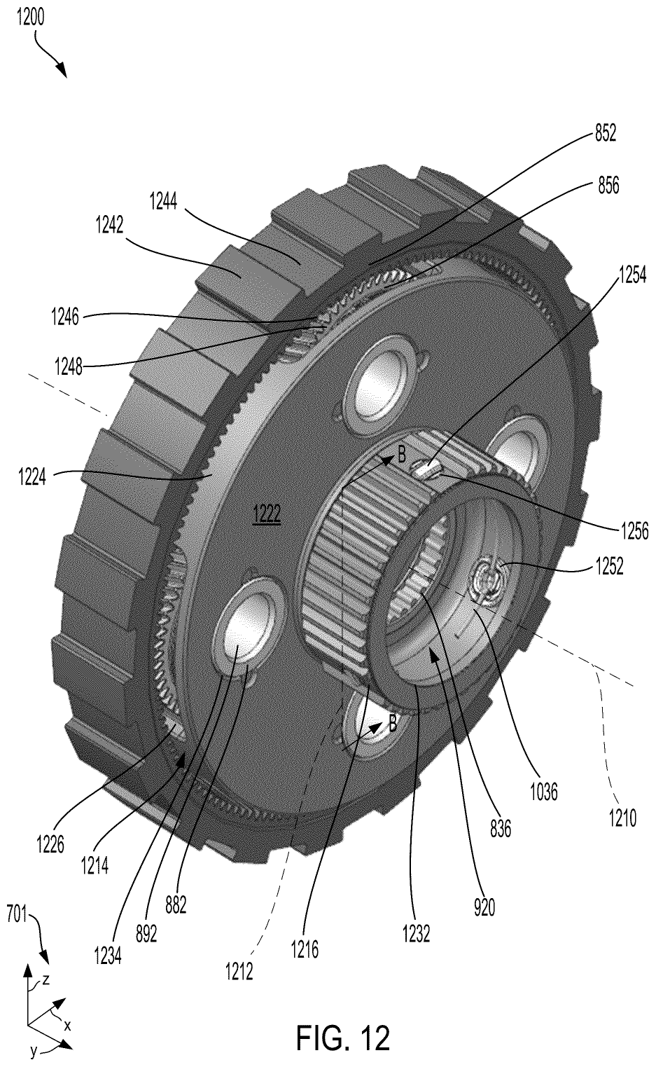

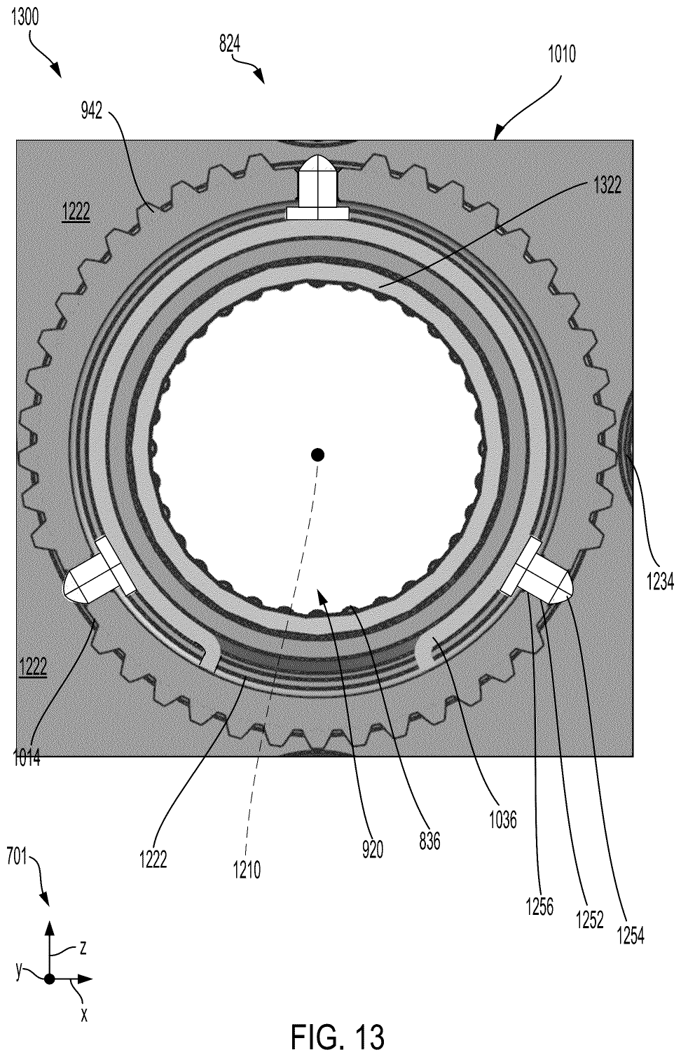

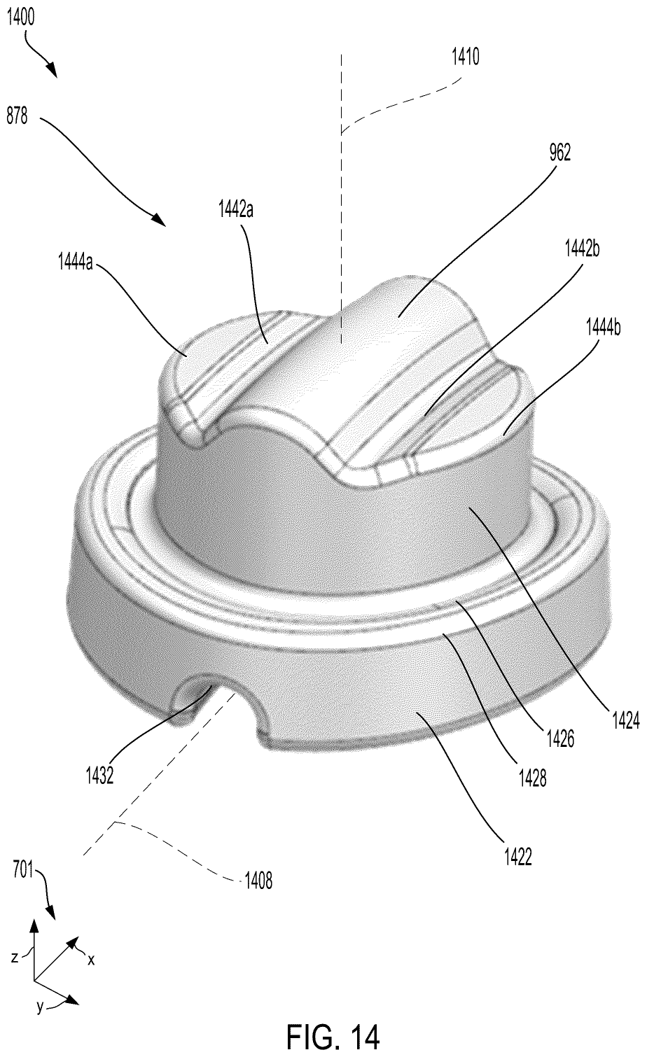

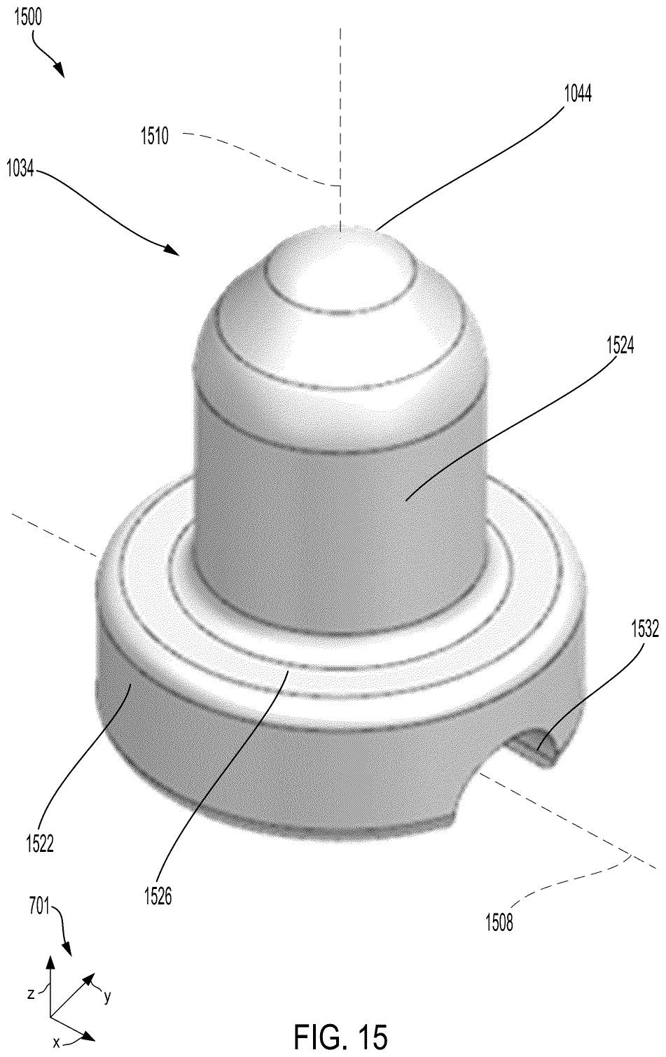

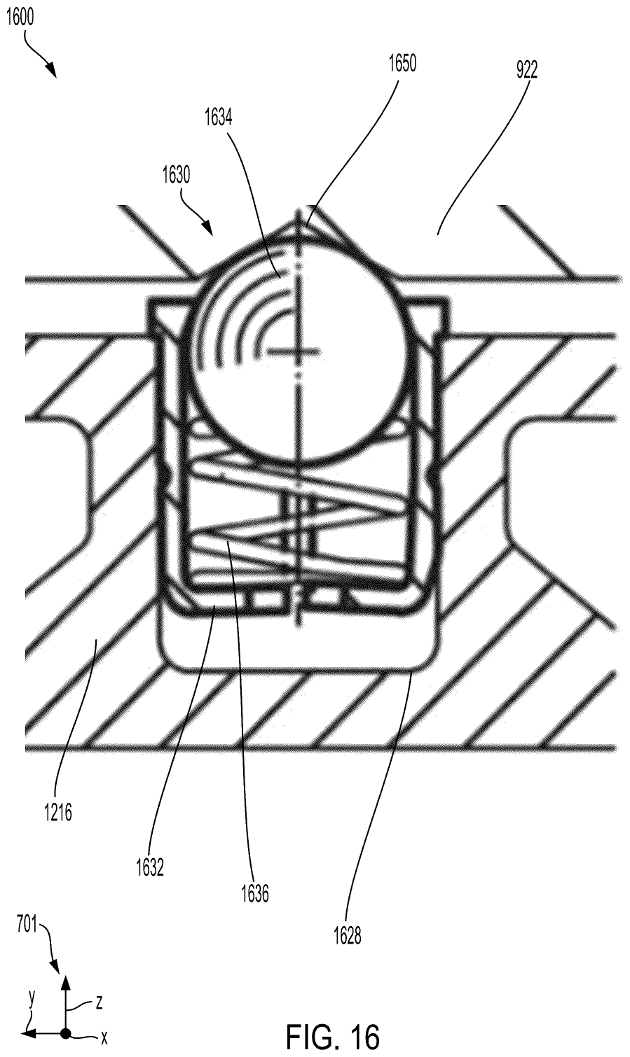

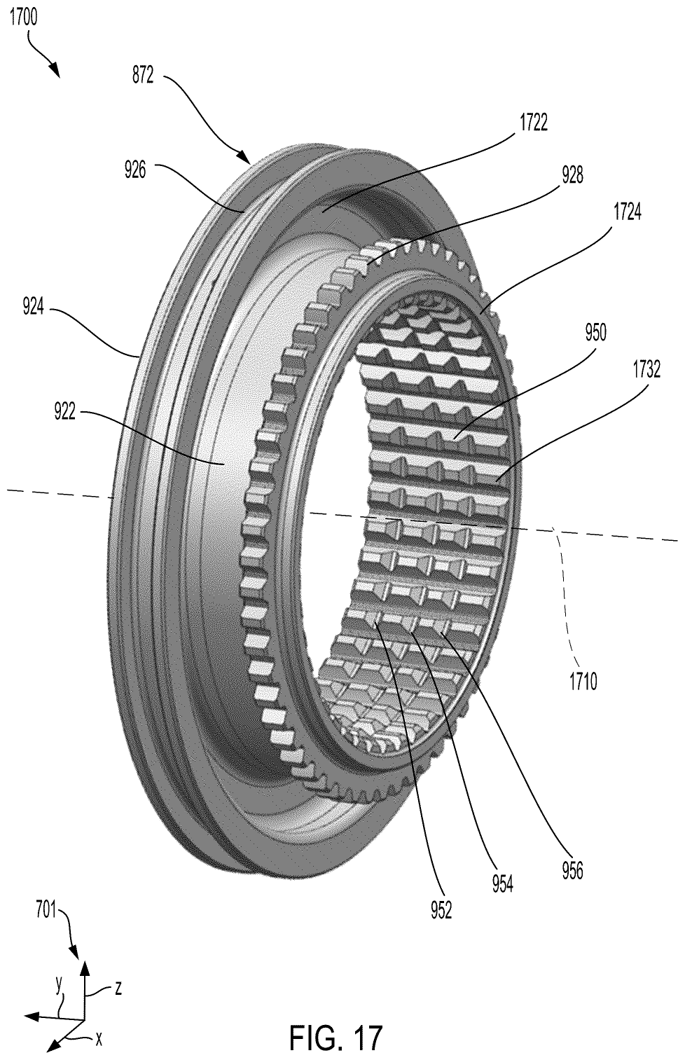

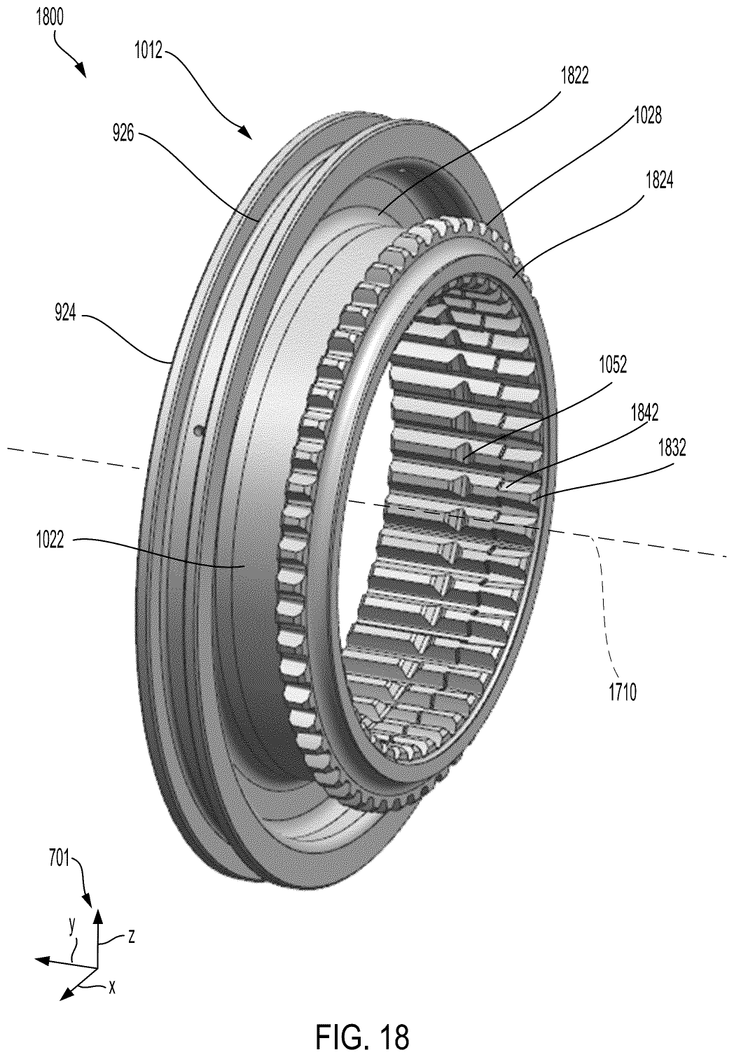

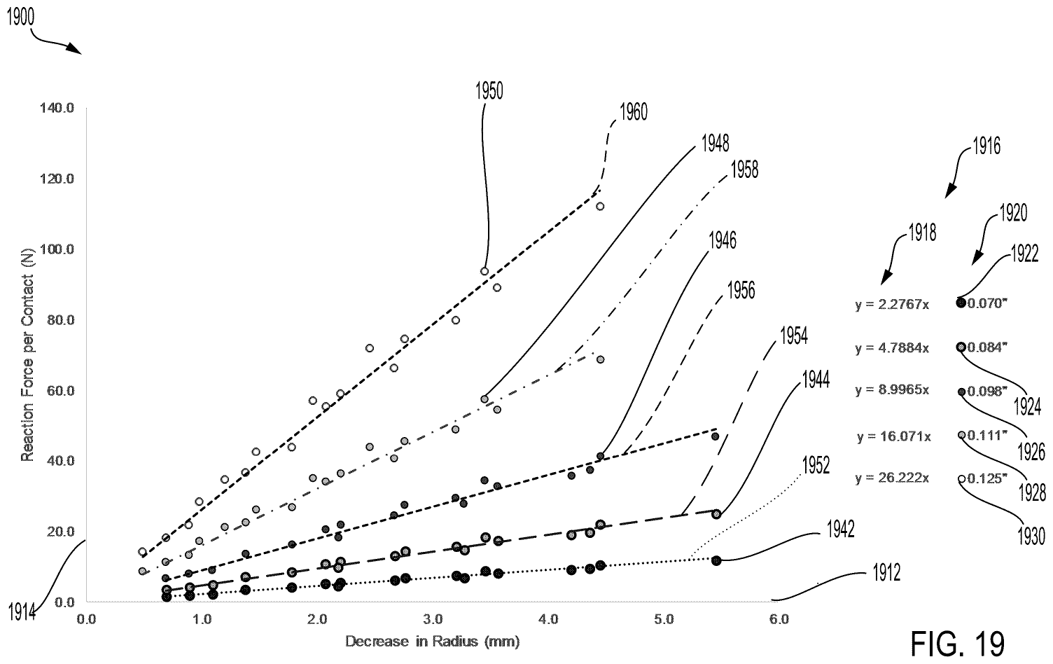

FIG. 7 shows a side view of an assembly that may house the use-case gearbox. FIG. 8 shows a sectional view of the use-case gearbox including the two speed shift system that includes the gear sets and clutches of a first embodiment. FIG. 9 shows a sectional view of an area of the use-case gearbox including a use-case shift system of a use case clutch including a shift sleeve and a carrier of a first embodiment. FIG. 10 shows a sectional view of an area of the use-case gearbox including a use-case shift system of a use case clutch including a shift sleeve and a carrier of a second embodiment. FIG. 11A shows the use case shift system including the sleeve and the carrier of the second embodiment in a low range position. FIG. 11B shows the use case shift system including the sleeve and the carrier of the second embodiment in a neutral position. FIG. 11C shows the use case shift system including the sleeve and the carrier of the second embodiment in a high range position. In the neutral position of FIG. 11B neither the lower range or higher range gear set may be engaged. FIG. 12 shows a side view of a gear set and a complementary carrier. FIG. 12 shows the carrier including the use-case holes, teeth, and detent inserts. FIG. 13 shows a side view of the gear set and the complementary carrier. FIGS. 12-13 show the gear set and carrier isolated from other components of the shift system and clutch of the present disclosure, such as the shift sleeve. FIG. 14 shows a side view of a first detent insert of a first embodiment. FIG. 15 shows a side view of a second detent insert of a second embodiment. FIGS. 14-15 show the first and second inserts isolated from other components and features of the gear set and carrier. FIG. 16 shows a sectional view of a third detent insert housed in an opening in a sleeve. The third detent insert of FIG. 16 may be a spring and ball detent assembly. FIG. 17 shows a side view of a first sleeve of a first embodiment. FIG. 18 shows a side view of a second sleeve of a second embodiment. FIG. 19 shows a force application diagram versus spring radius, including a plurality of data point plots and traces for different wire springs. The different wire springs may each be of a different wire diameter. The radii may be the radii of the spring.

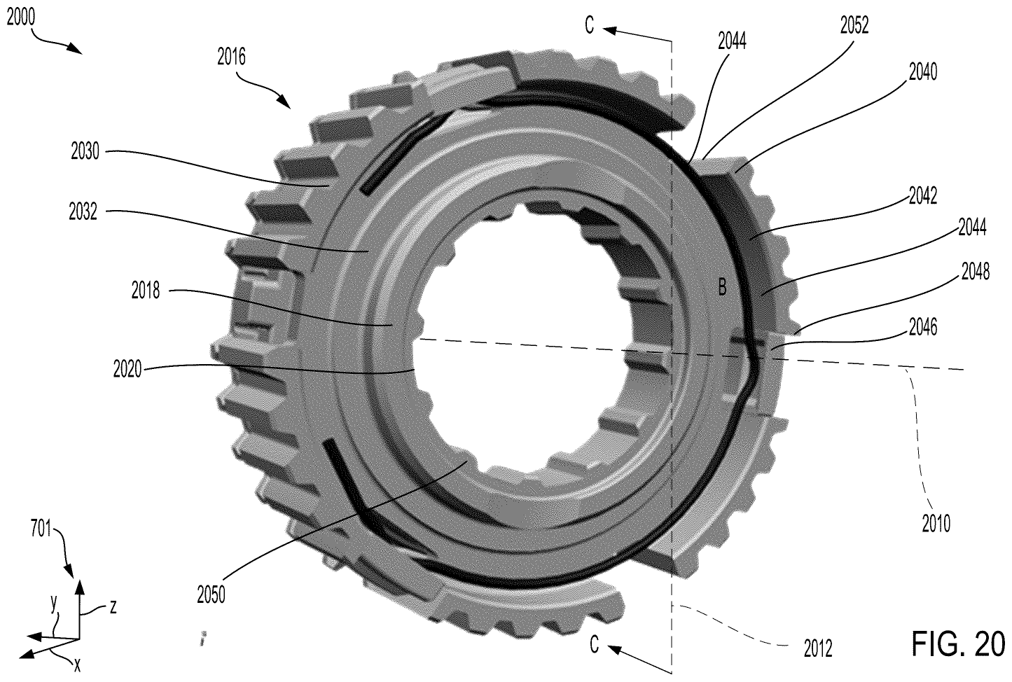

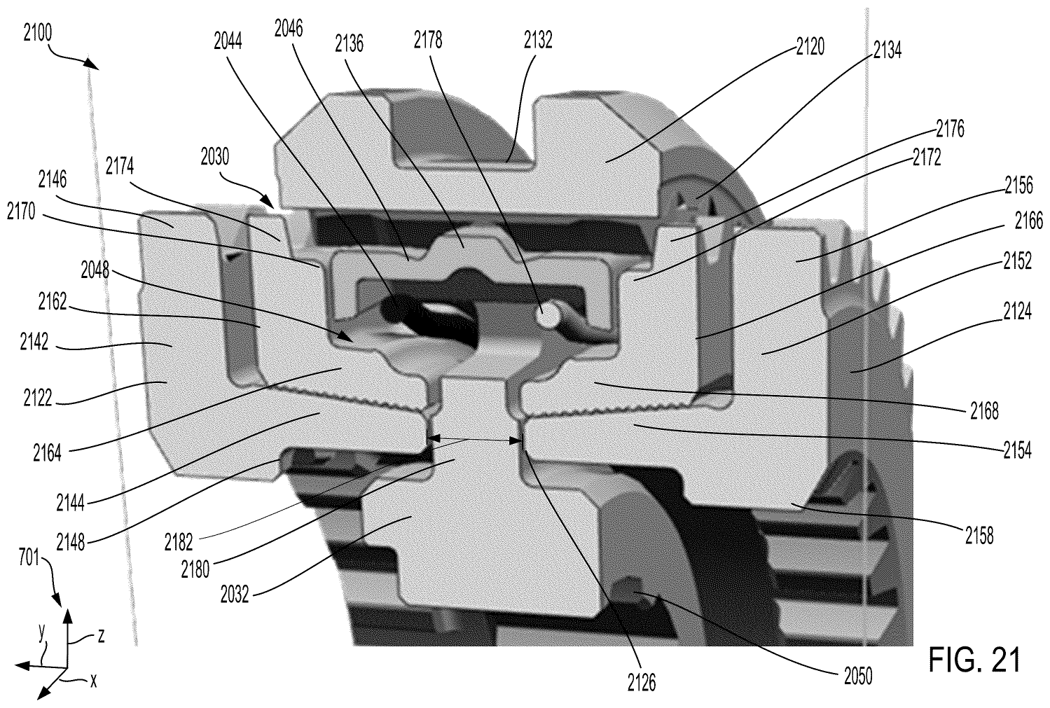

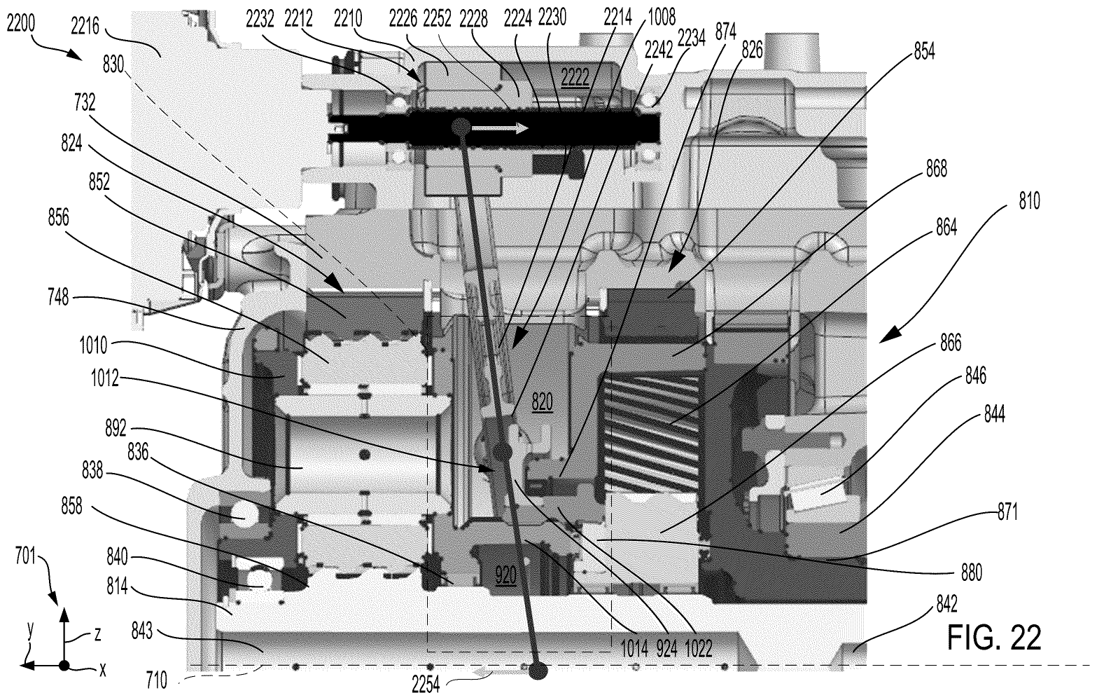

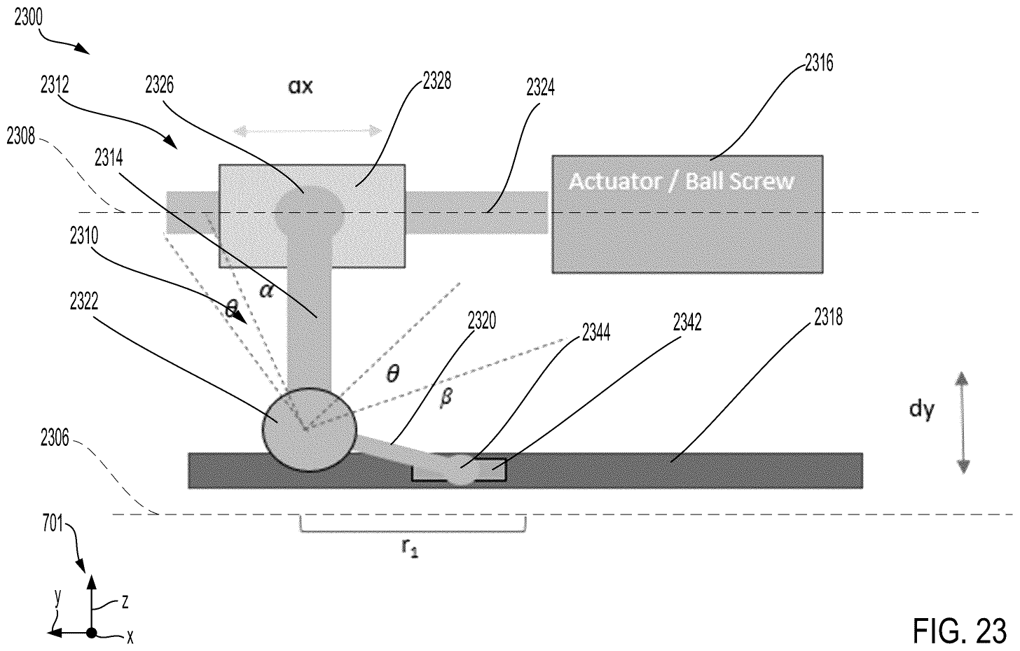

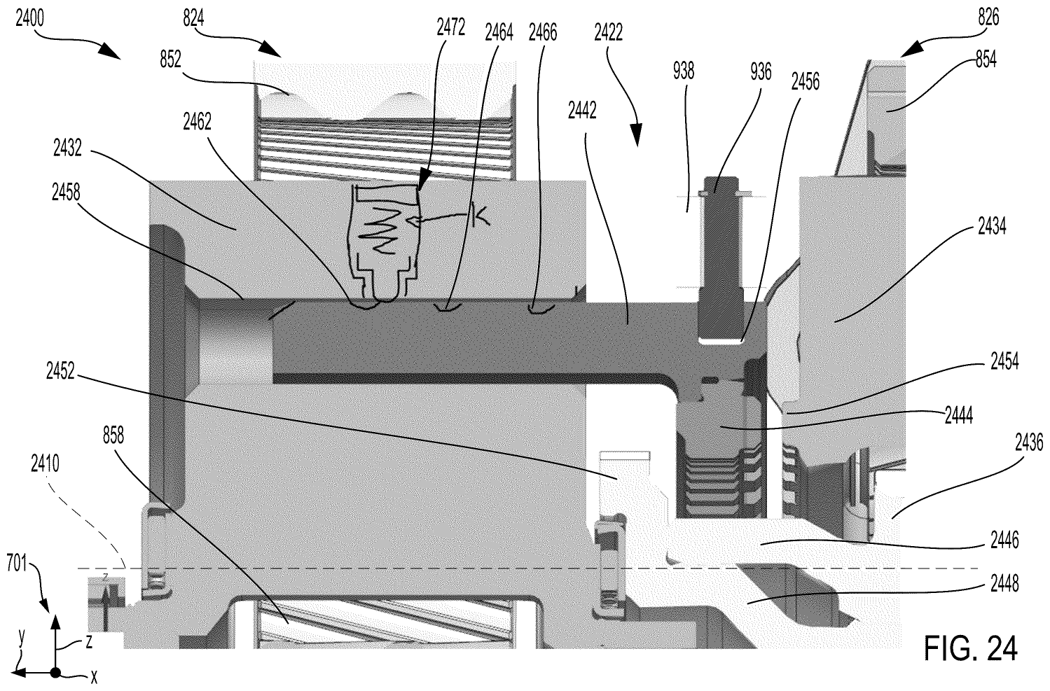

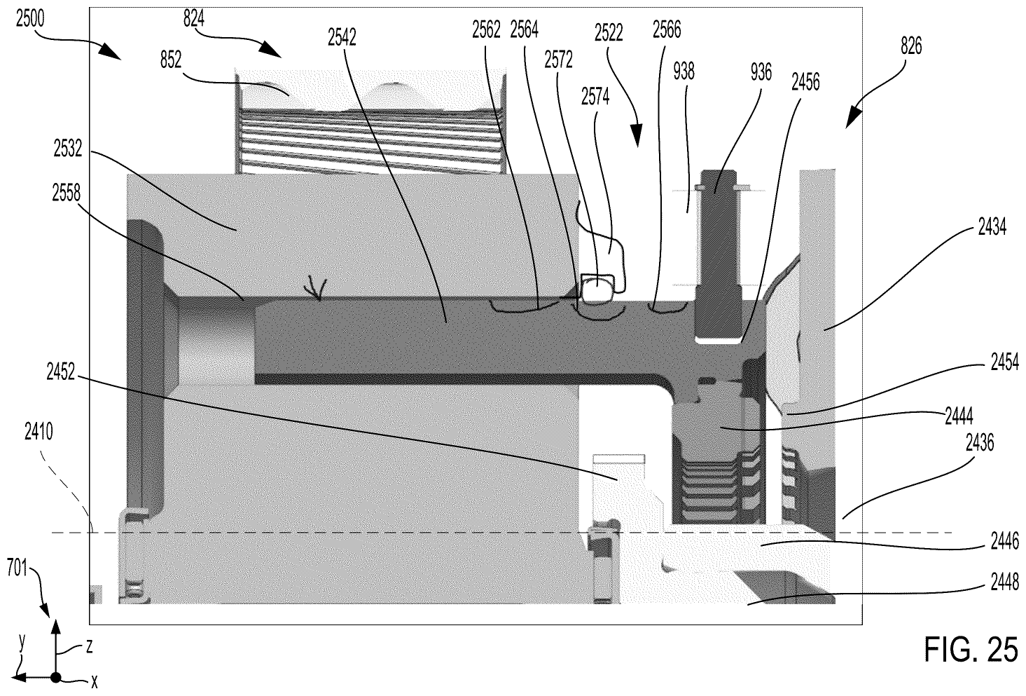

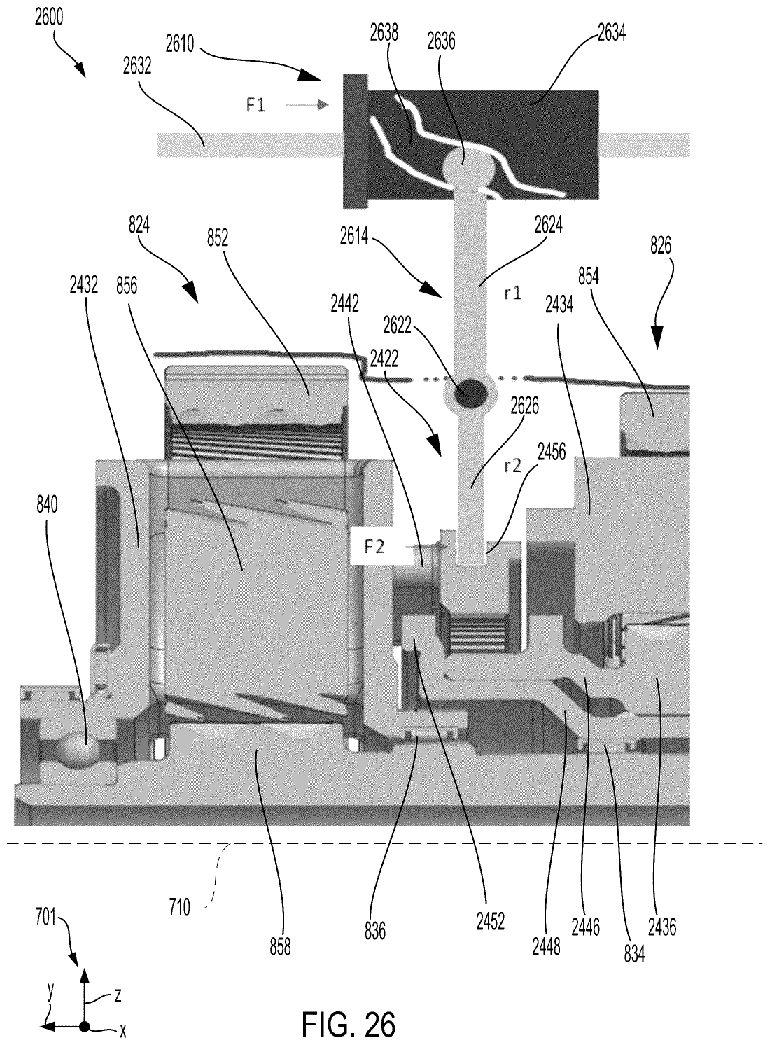

FIG. 20 shows a side view of an embodiment of a sleeve of a second embodiment. FIG. 21 shows a sectional view of an embodiment of a sleeve of the second embodiment. FIG. 22 shows a sectional view of an area of a use-case gear box and an actuator assembly of a first embodiment. FIG. 23 shows a view an actuator assembly of a second embodiment. FIG. 24 shows a sectional view of a first use-case clutch assembly and shift system including a sleeve and a carrier of a third embodiment. FIG. 25 shows a sectional view of a second use-case clutch assembly and shift system including a sleeve and a carrier of a fourth embodiment. Sleeves of the third embodiment and fourth embodiment of FIG. 24 and FIG. 25, respectively, may be carrier piloted. FIG. 26 shows a sectional view of an area of a use case gear box and an actuator assembly of a third embodiment.

FIG. 1 shows a vehicle 100 with a powertrain 102. The vehicle 100 is an electric vehicle (EV) such as an all-electric vehicle (e.g., a battery electric vehicle) or a hybrid electric vehicle. In the hybrid vehicle embodiment an engine may be included in the powertrain (e.g., an engine may provide mechanical power to a drive axle that is separate from the electric drive axle, elaborated upon herein) and in the all-electric vehicle embodiment an engine may be omitted from the powertrain.

The powertrain 102 includes an electric drive axle 104 with an electric machine 108 (e.g., an electric motor-generator) and a gearbox 106. The gearbox 106 is designed to operate in a lower range mode and a higher range mode. Thus, in the lower range mode, the gear ratio of the gearbox may be suitable for lower speed/higher torque operation such as in off-road environments. Conversely, in the higher range mode, the gear ratio of the gearbox may be suitable for higher speed/lower torque operation such as for on-road travel use. It will be appreciated that the stick diagram of FIG. 1 provides a topology of the vehicle, transmission, and corresponding components.

The electric drive axle may be a beam axle. A beam axle may be an axle with mechanical components structurally supporting one another and extending between drive wheels. For instance, the beam axle may be a structurally continuous axle spanning the drive wheels on a lateral axis, in one embodiment. Thus, wheels coupled to the axle may move in unison when articulating, during, for example, vehicle travel on uneven road surfaces. The beam axle may be coupled to a dependent suspension system, in one example. In such an example, the camber angle of the wheels may remain substantially constant as the suspension moves through its travel.

The electric machine 108 is electrically coupled to an energy storage device 110 (e.g., traction battery, capacitor, combinations thereof, and the like) via an inverter 112, for example. As such, the electric machine 108 may be an alternating current (AC) electric machine, in one example. However, in other examples, the electric machine may be a direct current (DC) electric machine and the inverter may therefore be omitted from the powertrain, in such an example. Arrows 114 signify the energy transfer between the electric machine 108, the inverter 112, and the energy storage device 110 that may occur during different modes of system operation. The electric machine 108 may include conventional components for generating rotational output (e.g., forward and reverse drive rotational output) and/or electrical energy for recharging the energy storage device 110 such as a rotor 116 electromagnetically interacting with a stator 118, to provide the aforementioned energy transfer functionality.

The electric machine 108 includes a rotor shaft 120 with a first bearing 122 and a second bearing 124 coupled thereto. The bearings 122, 124 as well as the other bearings described herein may include components such as inner races, outer races, roller elements (e.g., ball bearings, cylindrical rollers, tapered cylindrical rollers, and the like). It will be appreciated that the size and/or construction of the bearings may be selected based on expected rotational speeds of the components to which they are attached, packaging constraints, and the like. As such, the size and/or configuration of at least a portion of the bearings may vary, in some cases. However, at least a portion of the bearings may have similar sizes and/or constructions.

The bearings 122, 124 are shown positioned external to the rotor 116. However, other bearing arrangements with regard to the electric machine have been contemplated such as arrangements with alternative quantities, types, and/or locations of bearings.

The rotor shaft 120 is rotationally coupled (e.g., directly rotationally coupled) to a shaft 126 in the gearbox 106. Directly rotationally coupling the rotor shaft to the gearbox shaft enables the system's compactness to be increased.

The shaft 126 may have a bearing 127 coupled thereto to facilitate rotation thereof. A gear 128 may be fixedly coupled to the shaft 126 and therefore rotates therewith. The gear 128 is rotationally coupled to a clutch 130. The clutch 130 is designed to augment the mechanical power path from the gear 128 to a planetary assembly 132. The planetary assembly 132 includes a higher range planetary gear set 134 and a lower range planetary gear set 136. The higher range planetary gear set 134 is designed to provide a higher gear ratio than the lower range planetary gear set. Thus, the higher range planetary gear set 134 may be activated during or in anticipation of higher speed vehicle operation. Conversely, the lower range planetary gear set 136 may be activated during or in anticipation of lower speed vehicle travel. Activation of these gear sets may include directing the mechanical power path therethrough via clutch operation. The power paths and clutch operation are expanded upon herein.

The clutch 130 is designed to operate in a higher range position where a first interface 141 of the clutch 130 passes mechanical power to an interface 138 (e.g., splined interface, toothed interface, and the like). As such, in the higher range position, the first interface 141 mates with the interface 138. From the interface 138, power travels to a sun gear 140 of the higher range planetary gear set 134 via a gear 128 that is coupled to a shaft 142 which extends between the interface 138 and the sun gear 140. As such, the first interface 141 mates (e.g., meshes or otherwise mechanically attaches) with the interface 138, in the higher range position. In this way, mechanical power from the electric machine 108 bypasses the lower range planetary gear set 136. Further, in this higher range configuration, a sun gear 144 of the lower range planetary gear set 136 idles. Conversely, in a lower range position the clutch 130 transfers mechanical power from the gear 128 to the sun gear 144 of the lower range planetary gear set 136 via an interface 146 (e.g., a splined interface, a toothed interface, and the like) that mates with the clutch 130. Specifically, in the lower range configuration, a second interface 148 of the clutch 130 mates (e.g., meshes or otherwise mechanically attaches) with the interface 146, thereby facilitating the aforementioned power transfer.

The shaft 126 may extend through openings 150 in the sun gear 140 and the sun gear 144. In this way, the electric machine 108 and the planetary assembly 132 are arranged coaxially. The rotational axes 171 and 173 of the electric machine 108 and the planetary assembly 132, are provided for reference, respectively.

The lower range planetary gear set 136 further includes a ring gear 152, planet gears 154 which rotate on a carrier 156, and the sun gear 144. The higher range planetary gear set 134 further includes a ring gear 158, planet gears 160 which rotate on a carrier 162, and the sun gear 140.

The carrier 156 of the lower range planetary gear set 136 may be coupled to the sun gear 140 of the higher range planetary gear set 134 via a shaft 164. In this way, the higher and lower range planetary gear sets 134, 136 may be coupled in series. As such, when the lower and higher range gear sets are activated in a lower range operating mode, mechanical power may flow through the lower range planetary gear set 136 and then into the higher range planetary gear set 134 via the sun gear 140.

The carrier 162 of the higher range planetary gear set 134 is rotationally coupled to an output gear 166 via a shaft 168 and/or other suitable mechanical connection. The output gear 166 functions as an output of the gearbox 106 in a drive mode. However, it will be understood that the output gear 166 may transfer mechanical power back into the gearbox during a regeneration mode where mechanical power travels through the gearbox to the electric machine where electrical energy is generated, for example. Bearings 170 may be coupled to the shaft 168 to facilitate rotation of the output gear 166. The output gear 166 is coupled to a differential 172. To elaborate, the output gear 166 may mesh with a gear 174 fixedly coupled or otherwise attached to a case 176 of the differential 172.

The higher range planetary gear set 134 may be positioned axially between the lower range planetary gear set 136 and the output gear 166. In this way, the axle may achieve increased compactness when compared to other planetary arrangements which may position the output gear on an outer axial side 178 of the planetary assembly 132. However, other suitable gear set arrangements may be used, in other examples. Further, the clutch 130 may be positioned on the outer axial side 178 of the gearbox 106 to enable the clutch to be more easily actuated and accessed for installation and repair, for instance.

The differential 172 may include spider gears 180 that mesh with side gears 182. The side gears 182 may be rotationally coupled to axle shafts 184. In turn, the axle shafts 184 are rotationally coupled to drive wheels 186 that are on a drive surface 188. Bearings 189 may support and enable rotation of the differential case 176. The differential may be an open differential, in one example. In other examples, a locking differential, a limited slip differential, or a torque vectoring differential may be used in the gearbox.

The differential 172 may be offset from the gearbox 106 with regard to their axes of rotation. To elaborate, one of the axle shafts 184 may extend along a lateral side 187 of the electric machine 108. In this way, the axle's compactness may be increased, thereby reducing the likelihood of the axle structurally interfering with other vehicle systems. For instance, the suspension system may be more efficiently incorporated into the axle assembly when the electric drive axle's compactness is increased.

The vehicle 100 may further include a control system 190 with a controller 191. The controller 191 includes a processor 192 and memory 193. The memory 193 may hold instructions stored therein that when executed by the processor cause the controller 191 to perform the various methods, control techniques, and the like described herein. The processor 192 may include a microprocessor unit and/or other types of circuits. The memory 193 may include known data storage mediums such as random access memory, read only memory, keep alive memory, combinations thereof, and the like.

The controller 191 may receive various signals from sensors 194 positioned in different locations in the vehicle 100 and the gearbox 106. The sensors may include an electric machine speed sensor 195, an energy storage device state of charge sensor 196, wheel speed sensors 197, a gearbox speed sensor, and the like. The controller 191 may also send control signals to various actuators 198 coupled at different locations in the vehicle 100 and the gearbox system 106. For instance, the controller 191 may send signals to the inverter 112 to adjust the rotational speed and/or direction of the electric machine. The controller 191 may also send signals to the clutch 130 to switch the gearbox between higher range operation and lower range operation or vice versa. For instance, the clutch 130 may be placed in the higher range position to place the gearbox 106 in the higher range mode and conversely may be placed in the lower range position to place the gearbox in the lower range mode. Further, as previously discussed, the clutch may be placed in a neutral position to interrupt power flow through the gearbox. Actuators (e.g., hydraulic actuators, pneumatic actuators, electromechanical actuators, combinations thereof, and the like) in the clutch may be used to adjust the clutch. The other controllable components in the vehicle and the electric drive axle may function in a similar manner with regard to command signals and actuator adjustment.

The clutch 130 as well as the other clutches herein (e.g., the clutch 218, shown in FIG. 2) may be hydraulically actuated, pneumatically actuated, electromechanically actuated, and/or mechanically actuated. For instance, in one use-case example, a shift fork may be used to alter the position of the clutch.

The vehicle 100 may also include an input device 199 (e.g., a higher-lower range mode selector, console instrument panel, touch interface, touch panel, keyboard, combinations thereof, and the like). The input device 199, responsive to operator input, may generate range mode command (e.g., a higher range mode command or a lower range mode command). For instance, the input device may be a button, a switch, a slider, and the like that enables the operator to toggle between a higher range mode and a lower range mode. As such, in one use-case scenario the operator may switch to the lower range mode when the vehicle is traveling into or anticipated to travel into an off-road environment. Conversely, the operator may switch to the higher range mode when the vehicle is traveling on or anticipated to travel along roads that enable higher speed travel (e.g., paved roads such as highways, freeways, and the like). However, in other examples, the electric drive axle may be switched between the higher range mode and the lower range mode in a more automated manner using operating conditions that may be ascertained from sensor inputs and/or modeling. For instance, the axle may be switched between the higher and lower range drive modes based on vehicle speed, gearbox load, vehicle traction, electric machine speed, and the like. The control system 190 and associated components may be used to control the other electric drive axles described herein. As such, redundant description is forgone for concision.

The gearbox 106 may also be operated in a regeneration mode and a reverse mode. In the regenerative mode, energy is extracted from the gearbox using the electric machine 108 and transferred to the energy storage device 110, for example. For instance, the electric machine 108 may be placed in a generator mode where at least a portion of the rotational energy transferred from the drive wheels to the generator by way of the transmission is converted into electrical energy.

The gearbox 106 described herein with regard to FIG. 1 is able to achieve a selectable higher range mode and a lower range mode in a compact package, thereby enabling the vehicle employing the gearbox to be used in a wider variety of operating environments and driving scenarios. Due to the drive axle's expanded applicability, customer appeal is increased.

An axis system 151 is provided in FIG. 1, as well as FIGS. 2-4B, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. Rotational axes 153 of the axle shafts 184 are further provided for reference.

FIG. 2 shows another example of an electric drive axle 200. The electric drive axle 200 again includes an electric machine 202 and a gearbox 201. The electric machine 202 may be similar in structure and function to the electric machine 108, shown in FIG. 1. As such redundant description is omitted for concision. The electric machine 202 is coupled to an input shaft 203.

A sun gear 204 resides on the shaft 203 and therefore rotates therewith. The sun gear 204 is included in a higher range planetary gear set 206 which is included in a planetary assembly 208. The higher range planetary gear set 206 includes planet gears 210 which rotate on a carrier 212 and mesh with a first ring gear 214. The planetary assembly 208 further includes a lower range planetary gear set 216. A clutch 218 is designed to adjust the mechanical connection between the higher range planetary gear set 206 and the lower range planetary gear set 216. As such, the clutch 218 may be a multi-position dog clutch. To expound, the clutch 218, in a higher range positon may mechanically couple the carrier 212 to a carrier 220 in the lower range planetary gear set 216. The lower range planetary gear set 216 further includes planet gears 221. The planet gears 221 may rotate on the carrier 220 and mesh with a second ring gear 217. In the higher range position as well as the lower range position, an interface 219 in the clutch 218 mates with an interface 223 (e.g., splined surface, toothed surface, and the like) coupled to the carrier 212. Further, in the higher range position, an interface 225 in the clutch 218 mates with an interface 227 (e.g., a splined surface, toothed surface, and the like) on the carrier 220.

The carrier 220 is coupled to an output gear 222 via a shaft 224 or other suitable mechanical connection. Thus, in the higher range position of the clutch, mechanical power travels from carrier and carrier of the higher and lower planetary gear sets. In this way, the lower range planetary gear set may be bypassed with regard to the mechanical power path.

In the lower range position, the clutch 218 mechanically couples the carrier 212 in the higher range planetary gear set 206 to a sun gear 226 of the lower range planetary gear set 216 via the interface 228 (e.g., splined surface, toothed surface) on a shaft 230. To elaborate, the interface 225 in the clutch 218 mates with the interface 228 in the lower range position. As such, in the lower range mode, mechanical power flows from the carrier in the higher range planetary gear set 206 to the sun gear in the lower range planetary gear set 216.

The clutch 218 may further be designed to operate in a neutral position where the lower range planetary gear set 216 is decoupled from the higher range planetary gear set 206. In this way, mechanical power flow through the gearbox 201 can be selectively suspended, if desired.

The output gear 222 is again rotationally coupled to a differential 232. The differential 232 and corresponding components may be similar to the differential 172 and associated components, described above with regard to FIG. 1.

FIGS. 3A-3B depict mechanical power paths 300 and 302, respectively through the electric drive axle 104 operating in the higher range mode and the lower range mode, respectively. FIG. 3C depicts the configuration of the clutch 130. As shown in FIG. 3C, in the lower range mode the clutch is in the lower range position and in the higher range mode, the clutch is in the higher range position. It will be understood, that the clutch 218 may have a similar functionality. In one example, a ratio of the lower range mode may be 2.5-3 times higher than a ratio of the higher range mode. In this way, the gearbox may achieve a targeted ratio in both the lower and higher range modes, allowing the gearbox performance to more aptly suit the vehicle's intended operating environment.

As shown in FIG. 3A, in the higher range mode, the electric drive axle's power path 300 unfolds as follows: power is transferred from the electric machine 108 to the shaft 126. Next the power path moves from the shaft 126 to the sun gear 144 through the clutch 130 and the shaft 142. Next, the power path travels from the sun gear 140 to the carrier 162 via the planet gears 160. Next, power travels from the carrier 162 to the output gear 166 through the shaft 168. From the output gear 166 the power path moves through the differential 172 and to the drive wheels 186 via the axle shafts 184. The power path from the output gear 166 to the drive wheels 186 unfolds in a similar manner in the lower range mode and repeated description is omitted. In the power path 300 depicted in FIG. 3A, the power bypasses the lower range planetary gear set 136 and flows to the higher range planetary gear set 134.

As shown in FIG. 3B, in the lower range mode, the electric drive axle's power path 302 unfolds as follows: power is transferred from the electric machine 108 to the shaft 126. Next the power path moves from the shaft 126 to the sun gear 144 through the clutch 130. Next power travels to the carrier 156 via the planet gears 154. From the carrier 156, power travel to the sun gear 144 via the shaft 164. From the sun gear 144, power travels to the carrier 162 via the planet gears 160. Next power travels from the carrier 162 to the output gear 166 via the shaft 168. In this way, power flows through the lower range planetary gear set 136 and then to the higher range planetary gear set 134, in series, thereby achieving a lower ratio reduction, when compared to the higher range mode.

FIGS. 4A-4B depict power paths 400 and 402, respectively through the electric drive axle 200 operating in the higher range mode and the lower range mode, respectively.

As shown in FIG. 4A, in the higher range mode, the electric drive axle's power path 400 unfolds as follows: power is transferred from the electric machine 202 to the shaft 203. Next, power travels from the shaft 203 to the sun gear 204. From the sun gear 204, power travels to the carrier 212 via the planet gears 210. From the carrier 212, the power travels to the carrier 220 by way of the clutch 218. From the carrier 220 power then travels to the output gear 222 and then to the differential 232. In this way, power travels through the higher range planetary gear set 206 and then bypasses the lower range planetary gear set 216.

As shown in FIG. 4B, in the lower range mode, the electric drive axle's power path 402 unfolds as follows: power is transferred from the electric machine 202 to the shaft 203. Next, power travels from the shaft 203 to the sun gear 204. From the sun gear 204, power travels to the carrier 212 via the planet gears 210. From the carrier 212, the power travels through the clutch 218 to the sun gear 226 by way of the shaft 230. Next, power travels from the sun gear 226 to the planet gears 221 and then to the carrier 220. From the carrier 220, power travels to the shaft 224 and then to the output gear 222. From the output gear 222, power travels to the differential 232. In this way, mechanical power travels through the higher range planetary gear set 206 and the lower range planetary gear set 216, in series. The higher range planetary gear set 206 may be a higher gear a higher ratio planetary gear set compared to the lower range planetary gear set 216.

FIG. 5 shows a method 500 for operation of an electric drive axle. The method 500 specifically corresponds to operation of the electric drive axle 104, shown in FIGS. 1 and 3A-3B. However, the method 500 may be carried via other suitable electric drive axles, in other examples, such as the electric drive axle 200, shown in FIGS. 2 and 4A-4B. Furthermore, the method 500 may be implemented by a controller that includes a process and memory, as previously discussed.

At 502, the method includes determining operating conditions. The operating conditions may include input device position (e.g., range selector position), clutch configuration, gearbox speed, electric machine speed, vehicle speed, vehicle load, ambient temperature, and the like. The operating conditions may be ascertained via sensor inputs, modeling, look-up tables, and other suitable techniques.

Next at 504, the method judges whether to transition between a higher and lower range operating mode. Such as determination may be carried out responsive to driver input. For instance, the driver may interact with a range selector (e.g., a button, switch, touch interface, and the like) or other suitable input device to transition the gearbox into a higher range mode or a lower range mode. However, automatic range mode selection may be used, in other examples. For instance, the controller may automatically transition into the gearbox into the higher range mode or the lower range mode based on vehicle speed and/or vehicle load.

If it is determined that a transition between the higher range mode and the lower range mode should not occur (NO at 504) the method moves to 506, where the method includes sustaining the current gearbox operating strategy. For instance, the gearbox may be sustained in the higher range mode or the lower range mode. As such, the clutch may be held in its current position.

If it is determined that a transition between the higher range mode and the lower range mode should occur (YES at 504) the method moves to 508. At 508, the method includes altering the clutch configuration to transition the gearbox between the lower range mode and the higher range mode. Step 508 may therefore include at 510 moving the clutch into the lower range position to transition the gearbox from the higher range mode to the lower range mode. Conversely, to transition the gearbox from the lower range mode to the higher range mode, the method may include at 512, moving the clutch into the higher range position. In this way, the electric drive axle can be efficiently switched between higher range and lower range operation.

FIG. 6 illustrates a timing diagram 600 of a use-case control strategy for an electric drive axle, such as the electric drive axle 104 shown in FIGS. 1 and 3A-3B or the gearbox shown in FIGS. 2 and 4A-4B. In each graph of the timing diagram, time is indicated on the abscissa and increases from left to right. The ordinates for plots 602 indicate the operational states (i.e., “Higher Range Position” and “Lower Range Position”) of the clutch (e.g., the clutch 130, shown in FIG. 1, or the clutch 218, shown in FIG. 2). The ordinate for plot 604 indicate the range selector position (i.e., “Higher Range Position” and “Lower Range Position”).

At t1, the range selector position is toggled from the higher range position to the lower range position. Responsive to the operator induced range selector toggling, the clutch is placed in the lower range position. As such, the gearbox is placed in the higher range operating mode. In this way, the gearbox may efficiently transition between the lower range and higher range, thereby expanding the gearbox's adaptability.

A set of reference axes 701 are provided for comparison between views shown in FIGS. 7-18. The reference axes 701 indicate a y-axis, an x-axis, and a z-axis. In one example, the z-axis may be parallel with a direction of gravity and the x-y plane may be parallel with a horizontal plane that an assembly 706 may rest upon in FIGS. 7-11C and FIG. 16. In another example, the z-axis may be parallel with a direction of gravity and the x-y plane may be parallel with a horizontal plane that a gear set may rest upon in FIGS. 12-13. In another example, the z-axis may be parallel with a direction of gravity and the x-y plane may be parallel with a horizontal plane that a first detent insert and a second detent insert may rest upon in FIGS. 14-15. In another example, the z-axis may be parallel with a direction of gravity and the x-y plane may be parallel with a horizontal plane that a first detent insert and a second detent insert 1034 may rest upon in FIGS. 14-15. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

FIG. 7 shows a first view 700 of the assembly 706. The first view 700 may be a side view showing the assembly 706. An exterior 704 may represent a volume, such as packing space, about the assembly 706. The assembly 706 may have a first side 712 and a second side 714, wherein the first side 712 is opposite the second side 714. The assembly may be positioned about a first axis 708 and a second axis 710. The first axis 708 may be the axis for an axle, where components of the axle may be positioned about the first axis 708. A plurality of axle half shafts rotationally coupled to wheels may be centered about the first axis 708. The second axis 710 may be a rotational axis and a drive axis that an electric machine housed by the assembly 706 may be positioned about. The first axis 708 and second axis 710 may be parallel. The assembly 706 may be divided by a line 718, e.g., line A-A. A sectional plane taken on the line 718 is parallel with the first axis 708 and second axis 710. A sectional plane taken on the line 718 is collinear with the first axis 708. A sectional view may be taken on line 718, is shown in FIG. 8.

The assembly 706 may be a duel input assembly, able to receive two inputs of torque. The assembly 706 may receive input from an electric machine, such as an electric motor or an electric motor/generator. For example, the assembly 706 may receive inputs of torque from the electric machine 108 of FIG. 1 and/or the electric machine 202 of FIG. 2. Likewise, the assembly may be a planetary design configuration, and may include a gear set or a plurality of gear sets of a planetary configuration. The assembly 706 may include a powertrain or components of a powertrain of the present disclosure. The assembly 706 may include or include components of an axle assembly and an electric drive axle of the present disclosure. The axle assembly and/or electric drive axle may be rotationally coupled to components of a larger axle system. The assembly 706 may include a transmission, such as a gearbox, and may be referred to alternatively herein as the transmission assembly 706. The assembly 706 may include a transmission, such as a gearbox of the present disclosure. The transmission of the assembly 706 may include a planetary gear assembly of the present disclosure. For an example, the assembly 706 may include the powertrain 102 and the gearbox 106 of FIG. 1. For this example, the assembly 706 may include or be coupled to components of the electric drive axle 104 and the differential 172 of FIG. 1. The assembly 706 may therein include the planetary assembly 132 of FIG. 1. For another example, the assembly 706 may include the gearbox 201 of FIG. 2. For this example, the assembly 706 may include or be coupled to components of the electric drive axle 200 and the differential 232 of FIG. 2. The assembly 706 may therein include the planetary assembly 208 of FIG. 2.

The assembly 706 may include a first housing 722 and an electrical assembly 724. The electrical assembly 724 may include a plurality of electronic components and other electrical components. The components of the electrical assembly 724 may be housed and/or shielded by second housing 726. The electrical assembly 724 may also include a plurality of electronic components 728 that are not housed and may be unshielded. The electronic components 728 may be physically coupled to the second housing 726. The electrical assembly 724 may be physically coupled to the first housing 722 via the second housing 726. For example, of an embodiment of the electrical assembly 724, the second housing 726 may be mounted to the first housing 722 via plurality of mounts 730.

The first housing 722 may include a first housing section 732 and a second housing section 734. The first housing section 732 may house a transmission and complementary gear sets. The first housing section 732 may house a plurality of planetary gear sets. The second housing section 734 may house a differential assembly including a differential, such as the differential 172 and the differential 232. The second housing section 734 may also house portions of an axle assembly, such as a first half axle shaft and a second half axle shaft.

The first housing 722 may host and physically couple to a plurality of bells, such as a first bell 742, a second bell 744, a third bell 746, and a fourth bell 752. The first housing section 732 may host and physically couple the first bell 742, the third bell 746, and the fourth bell 752. The second housing section 734 may host and physically couple the second bell 744. The first bell 742, the second bell 744, third bell 746, and fourth bell 752 may be mounted and fastened to the first housing 722 via a plurality of fasteners. The first bell 742 may be fastened to the first housing section 732 via a plurality of first fasteners 748. The second bell 744 may be fastened to the second housing section 734 via a plurality of second fasteners 750. The fourth bell 752 may be fastened to the first housing section 732 via a plurality of third fasteners 754. The first bell 742 may be hosted by the first housing 722 on the second side 714. The second bell 744 may be hosted by the second housing section 734 between the first side 712 and second side 714. The third bell 746 may be hosted by the first housing 722 on the first side 712. The third bell 746 may include an interface region 756. The interface region 756 may be a structure or component of the third bell 746 that may receive an input from a rotational element. The input received by the interface region 756 may rotationally couple and input torque to the gear sets and other rotational elements of the transmission housed by the first housing section 732.

The second housing section 734 may have a first sleeve 762 and a second sleeve 764 positioned opposite to one another. The first sleeve 762 may be on the first side 712 and the second sleeve 764 may be on the second side 714 of the second housing section 734. The first sleeve 762 and second sleeve 764 may be positioned about the first axis 708, such as to be centered about the first axis 708. The first sleeve 762 and second sleeve 764 may each have complementary openings and passages, where the first sleeve 762 and second sleeve 764 may be positioned about the complementary openings and passages. For example, the first sleeve 762 may have a first opening 766. The first opening 766 may be a receiving hole, where components of the may be received by first sleeve 762 the second housing section via the first opening 766. Likewise, the second sleeve 764 may have a second opening, where the second opening approximately the same shape, dimensions and function to the first opening 766. The area of the first opening 766 and the area of second opening of the second sleeve 764 may be normal to the first axis 708. The first sleeve 762 and second sleeve 764 may be centered about the first axis 708, such that the centerlines of the first opening 766 and second opening may be approximately collinear with the first axis 708. The first sleeve 762 and the second sleeve 764 may each receive components of an axle assembly, such as axle half shafts. The first sleeve 762 and second sleeve 764 may be collars that may each support an axle half shaft. The first sleeve 762 may be mechanically supported by a plurality of first fins 768 of the second housing section 734. Likewise, the second sleeve 764 may be mechanically supported by a plurality of second fins 770 of the second housing section 734.

When received by the second housing section 734, the first sleeve 762 and second sleeve 764 may each receive and house portions of an axle. For example, the first sleeve 762 may receive and house portions of a first axle half shaft. The second sleeve 764 may receive and house portions of a second axle half shaft. The first axle half shaft and second axle half shaft may be opposite ends of an axle shaft. The first axle half shaft and second axle half shaft may output to wheels. Axle half shafts received by the first sleeve 762 or second sleeve 764 may be rotationally and drivingly couple to the differential housed by the second housing section 734. The differential housed by the second housing section 734 may output different torques and rotational speeds each axle half shaft received by the first sleeve 762 or second sleeve 764.

FIG. 8 shows a second view 800 of the assembly 706. The second view 800 may be a sectional view, and view 800 may be taken on line 718 of FIG. 7. The second view 800 shows a sectional view of an electric drive axle 810. The electric drive axle 810 may be an example embodiment of the electric drive axle 200 of FIG. 2. The electric drive axle 810 may be centered about the second axis 710, such that rotational elements of the electric drive axle 810 may be centered and positioned radially about the second axis 710. The second axis 710 may serve as a central and rotational axis for the rotational elements of the electric drive axle 810. The electric drive axle 810 may have a plurality of shafts. The electric drive axle 810 may drivingly couple to a shaft or another rotational element, such a gears. The electric drive axle 810 may rotationally couple to a first shaft 812. The electric drive axle 810 may include a second shaft 814. The first shaft 812 may rotationally couple to the second shaft 814. The first and second shafts 812, 814 may be positioned about the second axis 710, where first and second shafts 812, 814 may be centered on and positioned radially about the second axis 710. The first shaft 812 may be received by the assembly 706 via a first opening 818 of the interface region 756 and a second opening 819 of the housing 722. The first shaft 812 may extend through the first opening 818 and into the second opening 819 to rotationally couple the second shaft 814. The first shaft 812 may be an input to the assembly 706 and the electric drive axle 810. The first shaft 812 may output from an electric machine or be rotationally coupled to an output of an electric machine, such as electric machine 108 or electric machine 202 of FIG. 1 and FIG. 2, respectively.

The first housing section 732 may include a first cavity 816 and a second cavity 820. The electric drive axle 810 may include a plurality of gear sets, such as a first gear set 822, a second gear set 824, and a third gear set 826. The first cavity 816 may house the first gear set 822. The second cavity 820 may house the second gear set 824 and the third gear set 826. The first gear set 822, the second gear set 824, and the third gear set 826 may be positioned about the second shaft 814. The first gear set 822, the second gear set 824, and the third gear set 826 may be aligned such as to be approximately centered about and positioned radially about the second shaft 814. The first gear set 822 may be positioned nearest to the first side 712 and the second gear set 824 may be positioned nearest to the second side 714. The third gear set 826 may be positioned between the first gear set 822 and the second gear set 824 along the second axis 710. A first clutch assembly 828 may be positioned between the second gear set 824 and third gear set 826 along the second axis 710. The first clutch assembly 828 may be positioned about the second shaft 814, such as radially about the second shaft 814. A portion of the first clutch assembly 828, the second gear set 824, and the third gear set 826 may be enclosed by an area A 830. A rea A 830 may be represented by a plurality of dashed lines arranged in a rectangle. The first gear set 822 may rotationally couple to an output, such as a differential. The second gear set 824 and third gear set 826 are planetary gear sets. The second gear set 824 may be a higher range gear set, such as the higher range planetary gear set 206 of FIG. 2. The third gear set 826 may be a lower range gear set, such as lower range planetary gear set 216 of FIG. 2. The first clutch assembly 828 may rotationally couple to the second gear set 824. The first clutch assembly 828 may selectively couple to components of the third gear set 826, such as to rotationally couple to a specific component of the third gear set 826 when engaged in a way.

A plurality of bearings may be positioned about and support the first shaft 812 and/or the second shaft 814. A plurality of first bearings 832 may be positioned about and support the first shaft 812. The first bearings 832 may be positioned radially between the second opening 819 and the first shaft 812. A plurality of second bearings 834, a plurality of third bearings 836, and a plurality of fifth bearings 840 may be positioned about and support the second shaft 814. The second bearings 834 may be positioned radially between the second gear set 824 and the second shaft 814. The third bearings 836 and the fifth bearings 840 may be positioned radially between the third gear set 826 and the second shaft 814. A plurality of bearings may be positioned about components positioned about the second shaft 814. A plurality of fourth bearings 838 may be positioned about a feature, such as a first carrier 862, of the third gear set 826. The plurality of fourth bearings 838 may be positioned between surfaces of the first bell 742 and the feature of the third gear set 826. A plurality of sixth bearing 846 may be positioned radially between surfaces of the housing 722 and the first gear set 822.

The second shaft 814 may include a plurality of passages. The second shaft 814 may include a first passage 842 and a second passage 843. The first passage 842 and second passage 843 are centered on the second shaft 814, such as to have lengths parallel with the centerline of the shaft 814. The first passage 842 and second passage 843 may be fluid passages that may uptake and house work fluid. Work fluid housed in the first passage 842 and second passage 843 may be distributed outward by a plurality of tributary fluid passages. The opening of the first passage 842 may at the opposite end of the second shaft 814 from the opening of the second passage 843. For an example, the first passage 842 may have an opening nearest to the first side 712. The second passage 843 may have an opening nearest to the second side 714.

The first gear set 822 includes an output gear 844. The sixth bearings 846 may be positioned about and support the output gear 844. The output gear 844 may be the output gear 222 of FIG. 2. The output gear 844 may rotationally couple and transfer torque to an output, such as a differential housed by the first housing 722. The output gear 844 may mesh and rotationally couple to a gear 848. For one example the gear 848 may be a gear that inputs and transfers torque to the differential from the output gear 844. For this or another example, the gear 848 may be a gear comprised by the differential, such as a differential gear.

The second gear set 824 may include a first ring gear 852, a plurality of first planet gears 856, and a first sun gear 858. The first ring gear 852 may be positioned radially about the first planet gears 856. The first planet gears 856 may be positioned radially about the first sun gear 858. The plurality of first planet gears 856 may be supported by the first carrier 862 and a plurality of first pins 882. The first carrier 862 may therein be a first embodiment of planetary carrier that supports the first planet gears 856. The first planet gears 856 may spin about the first pins 882. The fourth bearings 838 may be positioned about and support the first carrier 862.

The third gear set 826 may include a second ring gear 854, a plurality of second planet gears 864, and a second sun gear 866. The second ring gear 854 may be positioned radially about the second planet gears 864. The second planet gears 864 may be positioned radially about the second sun gear 866. The plurality of second planet gears 864 may be supported by a second carrier 868 and a plurality of second pins 886. The second carrier 868 may therein be a planetary carrier. The second planet gears 864 may spin about the second pins 886.

The first clutch assembly 828 may be supported by and rotationally couple to a first sleeve 870 of the first carrier 862. The first sleeve 870 may be centered on and positioned radially about the second axis 710. The first clutch assembly 828 may be centered on and positioned radially about the first sleeve 870. The first sleeve 870 may extend along the second axis 710 toward the third gear set 826. The first clutch assembly 828 may be actuated in a first direction or a second direction along the second axis 710, such as when supported by the first sleeve 870. The first direction may be in a direction toward the first side 712. The second direction may be in a direction toward the second side 714. The first clutch assembly 828 may include a first shift sleeve 872 and a shift arm engagement 876. The shift sleeve 872 may be a structure including engaging component for the clutch assembly, for example the shift sleeve 872 may be a clutch collar. The first shift sleeve 872 may be in surface sharing contact with and supported by the first sleeve 870. The first shift sleeve 872 may also include the engaging components that may selectively couple to components of the third gear set 826. The shift arm engagement 876 may shiftingly couple to a shift arm, such as a shift fork. When shiftingly coupled to a shift arm, the shift arm engagement 876 and the first clutch assembly 828 may shift with a shift arm.

In addition to supporting the second planet gears 864, the second carrier 868 may support the portions of the output gear 844. The second carrier 868 may have a second sleeve 871. The output gear 844 may be positioned about and supported by the second sleeve 871. The first clutch assembly 828 may selectively couple the second carrier 868 or the sun gear 866 of the third gear set 826. When engaged in a first way, the first clutch assembly 828 may selectively couple to the second carrier 868. When selectively coupled via the first way, the first clutch assembly 828 may rotationally couple to the second carrier 868. When engaged in a second way, the first clutch assembly 828 may selectively couple to the second sun gear 866. When selectively coupled via the second way, the first clutch assembly 828 may rotationally couple to the second sun gear 866. The first clutch assembly 828 may selectively couple to the second carrier 868 via a first engagement component 874. The first shift sleeve 872 may selectively couple first engagement component 874. The second carrier 868 may physically couple to or comprise the first engagement component 874. The first clutch assembly 828 may selectively couple to the second sun gear 866 via a second engagement component 880. The first shift sleeve 872 may selectively couple the second engagement component 880. The sun gear 866 may physically couple to or comprise the second engagement component 880.

The first sleeve 870 may have a plurality of inserts that are embedded and may slide through passages. The inserts of the first sleeve 870 may be complementary to features of a shift sleeve of a clutch assembly. When fit to the complementary features of the shift sleeve, the inserts may prevent movement of the shift sleeve to positions along the second axis 710 without deliberate force above a threshold of force. For an example embodiment, the first sleeve 870 may have a plurality of first detent inserts 878. The first detent inserts 878 may be complementary to and fit with features of the first shift sleeve 872. When fit with the complementary features of the first shift sleeve 872, the first detent inserts 878 prevent movement of the first shift sleeve 872 to positions along the second axis 710 without a deliberate force above a threshold of force. The first shift sleeve 872 may therein be locked in a position by the first detent insert 878.

The second passage 843 may have a plurality of first channels 890. The first channels may extend radially outward from the second passage 843 to the outer surfaces of the second shaft 814. Work fluid, such as lubricant, housed by the second passage 843 may be sprayed radially outward via force from the rotation of the second shaft 814. Work fluid may be sprayed by the second passage 843 toward the second gear set 824 and the third gear set 826.

The first pins 882 and second pins 886 may be housed and supported by complementary passages of the first carrier 862 and second carrier 868, respectively. The first pins 882 may be supported via a plurality of seventh bearings 884. Each of the second pins 886 may be supported by a plurality of eighth bearings 888. The first pins 882 and second pins 886 may be hollow. The first pins 882 may each include a first through passage 892, where each of the first through passage 892 be centered about a centerline of each of the first pins 882. The second pins 886 may each include a second through passage 896, where each of the first through passages 896 be centered about a centerline of each of the second pins 886. The first through passages 892 and second through passages 896 may be through holes. Each of the first through passages 892 may have a plurality of second channels 894. Each of the second through passages 896 may have a plurality of third channels 898. The second channels 894 and third channels 898 may extend radially outward from the first through passages 892 and the second through passages 896, respectively.

FIG. 9 shows a third view 900 of the assembly 706. The third view 900 may be a sectional view, and the third view 900 may be taken on area A 830 of FIG. 8.

The first sleeve 870 may be a first embodiment of a sleeve for the first carrier 862 of the present disclosure. The first clutch assembly 828 and first shift sleeve 872 may be a first embodiment of a shift clutch assembly and shift sleeve, respectively, of the present disclosure.

The first sleeve 870 may curve about and include a cavity 920. The cavity 920 may be positioned the second shaft 814. A portion of the first detent inserts 878 may be housed in the cavity 920.

The first shift sleeve 872 may include a first sleeve component 922 and a shift component 924. The first sleeve component 922 may be in surface sharing contact with the first sleeve 870 and may include the engaging features of the first shift sleeve 872. Engaging features of the first sleeve component 922 may include a plurality of first engaging teeth 928. The first engaging teeth 928 may be dog teeth, and the first engaging teeth 928 may mesh/engage with complementary features of the engagement component 874. The first sleeve component 922 may also include a plurality of second engaging teeth. The second engaging teeth may engage with the second engagement component 880. The shift component 924 may include a first groove 926 and a second groove 930. The first groove 926 may curve radially about and depress radially into the shift component 924. The first groove 926 may curve radially about the second groove 930. The shift component 924 may physically couple to the shift arm engagement 876, such as via the shift arm engagement 876 fitting to the groove 926. The second groove 930 may catch work fluid.

The engagement component 874 of FIG. 8 may include or be a drum 932. The drum 932 may be positioned radially about the first sleeve 870 and the first sleeve component 922. The drum 932 may include a plurality of first engagement teeth 934. The first engagement teeth 934 may be dog teeth. The first engaging teeth 928 may be complementary to the first engagement teeth 934, such that the first engaging teeth 928 may mesh with the first engagement teeth 934. The second engagement component 880 may have a plurality of second engagement teeth 940. The second engagement teeth 940 may be complementary to and mesh with other teeth of the first sleeve component 922, such that the first sleeve component 922 may selectively couple to the second engagement component 880.

The shift arm engagement 876 may include a coupling component 936 and an actuator component 938. The coupling component 936 may insert into the groove 926, where the coupling component 936 may physically couple to the shift arm engagement 876. The actuator component 938 may shiftingly couple to an actuator, such that the actuator may shift the shift arm engagement 876. The shift arm engagement 876 may slide the first shift sleeve 872.

The first sleeve 870 may have a plurality of first teeth 942 and a plurality of first passages 944. The first teeth 942 may be placed radially about and physically coupled to an outer surface of the first sleeve 870. Likewise, the first passages 944 may extend radially outward from the cavity 920, through the material of the first sleeve 870. The first shift sleeve 872 may have a plurality of grooves, such as a first groove 952, a second groove 954, and a third groove 956 of the first sleeve component 922. There may be a plurality spacing features 950 between the first groove 952, the second groove 954, and the third groove 956.

The first detent inserts 878 may be complementary to the first passages 944, such that the first detent inserts 878 may be fit to and slide along the centerlines of the first passages 944. Each of the first detent inserts 878 may have a tooth 962 and a cavity 964. The tooth 962 may be complementary to the first groove 952, the second groove 954, and the third groove 956, such as to be fit to the first groove 952, the second groove 954, and the third groove 956. When mated to the first groove 952, the second groove 954, or the third groove 956, the tooth 962 may prevent movement of the first shift sleeve 872 without a deliberate force above a threshold of force. Each fitting of the tooth 962 and groove may a position of the first clutch assembly 828 to enable a mode of power flow between the second gear set 824 and third gear set 826 of FIG. 8. For example, when the tooth 962 is mated to the first groove 952, the first clutch assembly 828 may be engaged in a first way, and the sleeve component 922 selectively couples the second engagement component 880. When engaged in the first way, the first clutch assembly 828 may enable a lower range mode between the second gear set 824 and third gear set 826. For another example, when the tooth 962 is mated to the second groove 954, the first clutch assembly 828 may be engaged in a second way, and the sleeve component 922 may not selectively couple to either the first engagement component 874 or second engagement component 880. When engaged in the second way, the first clutch assembly 828 may enable a neutral mode between the second gear set 824 and third gear set 826. For another example, when the tooth 962 is mated to the third groove 956, the first clutch assembly 828 may be engaged in a third way, and the sleeve component 922 selectively couples the second engagement component 880.

The shift component 924 may have a channel 972. The channel 972 may extend radially outward from the second groove 930 to the first groove 926, fluidly coupling the second groove 930 to the first groove 926. The shift arm engagement 876 may be lubricated via the channel 972.

FIG. 10 shows a fourth view 1000 of the assembly 706. The fourth view 1000 may be a sectional view, and the fourth view 1000 may be taken on area A 830 of FIG. 8.

The fourth view 1000 shows a second clutch assembly 1008 and a third carrier 1010. The second clutch assembly 1008 may be a second embodiment of a clutch assembly of the present disclosure. The second clutch assembly 1008 share features and components with the first clutch assembly 828, such as the first shift arm engagement 876. The second clutch assembly 1008 may also engage and selectively couple the second carrier 868 and the sun gear 866, as the first clutch assembly 828. For example, a second shift sleeve 1012 of the second clutch assembly 1008 may selectively couple to the first engagement component 874 of FIG. 8 and drum 932 or the second engagement component 880. The third carrier 1010 may be a second embodiment of a planetary carrier that may support and house the first planet gears 856 and the first pins 882 of FIG. 8. The third carrier 1010 may share components and features with the first carrier 862 that may not be reintroduced. Likewise, as an example, third carrier 1010 may have the same dimensions and features as the first carrier 862.

The third carrier 1010 may include a third sleeve 1014. The second clutch assembly 1008 may be supported by and rotationally couple to the third sleeve 1014. The third sleeve 1014 may be centered on and positioned radially about the second axis 710. The second clutch assembly 1008 may be centered on and positioned radially about the third sleeve 1014. The third sleeve 1014 may extend along the second axis 710 toward the third gear set 826 of FIG. 8. The second shift sleeve 1012 may be in surface sharing contact with and supported by the third sleeve 1014. The second shift sleeve 1012 may also include the engaging components that may selectively couple to components of the third gear set 826.

The second shift sleeve 1012 may include the shift component 924 and a second sleeve component 1022. The second sleeve component 1022 may be in surface sharing contact with the third sleeve 1014 and may include the engaging features of the first shift sleeve 872. Engaging features of the second sleeve component 1022 may include a plurality of third engaging teeth 1028. The third engaging teeth 1028 may be dog teeth. The third engaging teeth 1028 may mesh/engage with complementary features of the engagement component 874, such as the first engagement teeth 934. The second sleeve component 1022 may also include a plurality of fourth engaging teeth. The fourth engaging teeth may mesh/engage with complementary components of the second engagement component 880, such as the second engagement teeth 940.

The third sleeve 1014 may have a plurality of second teeth 1042 and a plurality of second passages 1032. The second teeth 1042 may be placed radially about and physically coupled to an outer surface of the first sleeve 870. Likewise, the second passages 1032 may extend radially outward from the cavity 920, through the material of the third sleeve 1014. The second detent inserts 1034 may be complementary to the second passages 1032. Each of the second detent inserts 1034 may be fit to and slide along the centerlines of the second passages 1032. Each of the second detent inserts 1034 may have a tooth 1044. The tooth 1044 extend radially above the third sleeve 1014, such as when a second detent insert of the second detent inserts 1034 is slid to a maximum distance in a radially outward direction through one of the second passages 1032. Each of the second detent inserts 1034 may be complementary to a spring 1036. The spring 1036 may be a wire spring. The second detent inserts 1034 may couple to the spring 1036. The spring 1036 may press and slide the second detent inserts 1034 in a radially outward direction from the spring 1036, via the force of the spring 1036. For an example, the force of the spring 1036 may press the second detent inserts 1034 radially outward from the cavity 920 and through the second passages 1032.

It is to be appreciated, that the spring 1036 may be complementary to the first detent inserts 878 of FIGS. 8-9. The first detent inserts 878 may couple to the spring 1036. The spring 1036 may press and slide first detent inserts 878 in a radially outward direction from the spring 1036, via the force of the spring 1036. For an example, the force of the spring 1036 may press the first detent inserts 878 radially outward from the cavity 920 and through the second passages 1032.

The second shift sleeve 1012 may have at least a groove, such as a groove 1052 of the second sleeve component 1022. A bout the groove 1052 spacing 1054 of material. The spacing 1054 may be fit to the second teeth 1042, such that the second sleeve component 1022 may slide along the second teeth 1042.

The tooth 1044 of each of the second detent inserts 1034 may be complementary to the groove 1052, such as to be fit to the groove 1052. When mated to the groove 1052, tooth 1044 may prevent movement of the second shift sleeve 1012 without a deliberate force above a threshold of force. The mating of the tooth 1044 and the groove 1052 may lock the second clutch assembly 1008 at a position for a mode of power flow between the second gear set 824 and third gear set 826 of FIG. 8. For example, when tooth 1044 is mated to the groove 1052, the second clutch assembly 1008 may be engaged in a second way, and the second sleeve component 1022 may not selectively couple to either the first engagement component 874 or the second engagement component 880. When engaged in the second way, the second clutch assembly 1008 may enable a neutral mode between the second gear set 824 and third gear set 826.

It is to be appreciated, that if the first carrier 862 and third carrier 1010 are the same type of carrier sharing the same dimensions, the first passages 944 may have the same dimensions as the second passages 1032. Likewise, the first teeth 942 may have the same dimensions as the second teeth 1042.

FIG. 11A-11C show the fourth view 1000 of the assembly 706. FIG. 11A shows the second clutch assembly 1008 in a first position 1110. FIG. 11B shows the second clutch assembly 1008 in a second position 1120. FIG. 11C shows the second clutch assembly 1008 in a third position 1130. FIG. 11A-11C may be referred to collectively herein.

In the first position 1110 the second clutch assembly 1008 may be selectively and rotationally coupled to the second sun gear 866. In the first position 1110 the second clutch assembly 1008 may be engaged in a first way such as to engage a lower range mode between the second gear set 824 and third gear set 826 of FIG. 8. In the first position 1110 the second sleeve component 1022 selectively couples the second engagement component 880.

In the second position 1120 the second clutch assembly 1008 may not be selectively or rotationally coupled to the second sun gear 866 or the second carrier 868. In the second position 1120 the second clutch assembly 1008 may be engaged in a second way such as to engage a neutral mode between the second gear set 824 and third gear set 826.

In the third position 1130 the second clutch assembly 1008 may be selectively and rotationally coupled to the second carrier 868. In the third position 1130 the second clutch assembly 1008 may be engaged in a third way such as to engage a higher range mode between the second gear set 824 and third gear set 826. In the third position 1130 the second sleeve component 1022 selectively couples the first engagement component 874.

FIG. 12 shows a fifth view 1200 of the second gear set 824. The fifth view 1200 may be a side view of the second gear set 824, where the second gear set 824 is isolated from other components and features of the assembly 706 of FIG. 7.

The second gear set 824 may be centered about an axis 1210. The axis 1210 may be parallel with or may be the second axis 710. The second gear set 824 may be sectioned by a line 1212, e.g., line B-B. A plane taken on the line B-B may be normal to the axis 1210.

The third gear set may include a carrier 1214 and a sleeve 1216. The carrier 1214 may be either the first carrier 862 of FIG. 8 or third carrier 1010 of FIG. 10. With respect to the carrier 1214, the sleeve 1216 may be either the first sleeve 870 or the third sleeve 1014 of FIG. 10.

The carrier 1214 may have a first surface 1222 that extends radially outward from the sleeve 1216. The carrier 1214 may have a second surface 1224 that curves about the perimeter of the carrier 1214. The second surface 1224 may have a plurality of openings 1226. The first planet gears 856 may mesh with the first ring gear 852 via the openings 1226. The sleeve 1216 may include a socket 1232 about the cavity 920. The first surface 1222 may be open to a plurality of passages 1234. The first pins 882 may be received by, housed in, and supported by the passages 1234.

The first ring gear 852 may have a plurality of first teeth 1242 and a plurality of second teeth 1246. There may be a plurality of troughs 1244, where there may be a trough of the troughs 1244 between each of the first teeth 1242. The first planet gears 856 may have a plurality of third teeth 1248. The third teeth 1248 and second teeth 1246 may mesh such that the first planet gears 856 may rotate within the first ring gear 852 and about the axis 1210.

The sleeve 1216 may have a plurality of passages 1256. The passages 1256 may be holes. A detent insert 1252 with a tooth 1254 may be fit to each of the passages 1256. There may be a plurality of detent inserts 1252, where each of the passages 1256 may have a detent insert of the detent inserts 1252. The detent inserts 1252 may be physically coupled to the spring 1036, such as via a snap fit.

FIG. 13 shows a sixth view 1300 of the second gear set 824. The sixth view 1300 may be a sectional view, and sixth view 1300 may be taken on line 1212 of FIG. 7.

The second gear set 824 may include a band 1322. The band 1322 may support the third bearings 836.

FIG. 14 shows a seventh view 1400 of the first detent insert 878. The seventh view 1400 may be a side view of the first detent insert 878, where the first detent insert 878 is isolated from other components and features of the assembly 706 of FIG. 7. The first detent insert 878 may be positioned about a first axis 1408 and centered about a second axis 1410.

The first detent insert 878 may include a column 1424 and a land 1422. The tooth 962 is located atop the column 1424, and the land 1422 may be positioned at the bottom of the column 1424. The tooth 962 may be opposite land 1422 with respect to the column 1424.

The land may have a first groove 1426. The first groove 1426 may be positioned radially between the circumference of the column 1424 and a rim 1428 of the land 1422.

The land may have a second groove 1432. The second groove 1432 may receive and couple the first detent insert 878 to a wire spring, such as the spring 1036 of FIG. 10. The second groove 1432 may be positioned about the first axis 1408.

The tooth 962 may be positioned between a plurality of valleys and flanks. The tooth 962 may be between a first valley 1442a and a second valley 1442b. The first valley 1442a may curve away from the tooth 962 to form a first flank 1444a with the column 1424. The second valley 1442b may curve away from the tooth 962 to form a second flank 1444b with the column 1424. The first valley 1442a and the first flank 1444a and may be opposite the tooth 962 from the second valley 1442b and the second flank 1444b.

FIG. 15 shows an eighth view 1500 of the second detent insert 1034. The eighth view 1500 may be a side view of the second detent insert 1034, where the second detent insert 1034 is isolated from other components and features of the assembly 706 of FIG. 7. The second detent insert 1034 may be positioned about a first axis 1508 and centered about a second axis 1510.

The second detent insert 1034 may include a column 1524 and a land 1522. The tooth 1044 is located atop the column 1524, and the land 1522 may be positioned at the bottom of the column 1524. The tooth 1044 may be opposite land 1522 with respect to the column 1524.

The land 1522 may have a surface 1526. The surface 1526 may be positioned radially between the circumference of the column 1524 and the circumference of the land 1422. The surface 1526 may extend radially from the column 1524. The 1524 is created by the difference in the diameter of the land 1522 and the diameter of the column 1524. For a first example the surface 1526 may be flat and normal to the second axis 1510. For a second example, the surface 1526 may have a groove or an indentation. The groove, such as a groove similar to the first groove 1426 of FIG. 14, or the indentation may be positioned radially within the perimeter of the land 1522 and radially about the column 1524.

The land 1522 may have a first groove 1532. The first groove 1532 may receive and couple the second detent insert 1034 to a wire spring, such as the spring 1036 of FIG. 10. The first groove 1532 may be positioned about the first axis 1508.

FIG. 16 shows a ninth view 1600 of a third detent insert 1630. The ninth view 1600 may be a sectional view of the third detent insert 830 and the sleeve 1216.

The third detent insert 1630 may be housed in an opening 1628 of the sleeve 1216. The opening 1628 may be a passage with a base. The third detent insert 1630 may be complementary to features of a shift sleeve that may include a sleeve component, such as the first sleeve component 922. For example, when fit with the complementary features of the first sleeve component 922, the third detent insert 1630 may prevent movement of the first sleeve component 922 to positions along the second axis 710 of FIG. 7 without a deliberate force above a threshold of force to the first sleeve component 922.

The third detent insert 1630 may be a ball spring detent, including a ball 1634 and a spring 1636. The ball 1634 may be a ball bearing. The ball 1634 and spring 1636 may be housed in a housing 1632. The housing 1632 may be fit to the opening 1628. The housing 1632 may abut the surfaces of the opening 1628.

The force of the spring 1636 may push the ball 1634 outward from the sleeve 1216. The ball 1634 may be complementary to a groove 1650, such that the ball 1634 may fit and mate with the groove 1650. The spring 1636 may extend the ball 1634 to mate with the groove 1650. When the ball 1634 is mated with the groove 1650, the third detent insert 1630 may prevent movement of the of the first sleeve component 922 to positions along the second axis 710 without a deliberate force above a threshold of force to the first sleeve component 922. The groove 1650 may be one of the first groove 952, the second groove 954, or the third groove 956 of FIG. 9.

FIG. 17 shows a tenth view 1700 of the first shift sleeve 872. The tenth view 1700 may be a side view of the first shift sleeve 872, where the first shift sleeve 872 is isolated from other components and features of the assembly 706 of FIG. 7. The first shift sleeve 872 may be positioned about an axis 1710. The first shift sleeve 872 may be centered and positioned radially about the axis 1710. The axis 1710 may be parallel with or be the second axis 710.

The first shift sleeve 872 may include a valley 1722. The valley 1722 may be formed by surfaces of the first sleeve component 922 and the shift component 924. The valley 1722 may include the second groove 930. The first shift sleeve 872 may also include a first face 1724. The first sleeve component 922 may include the first face 1724 positioned about the axis 1210.

The first shift sleeve 872 may have a plurality of second teeth 1732. The second teeth 1732 may mesh with second engagement teeth 940 of FIGS. 9-10.

FIG. 18 shows an eleventh view 1800 of the second shift sleeve 1012. The eleventh view 1800 may be a side view of the second shift sleeve 1012, where the second shift sleeve 1012 is isolated from other components and features of the assembly 706 of FIG. 7. The second shift sleeve 1012 may be centered and positioned radially about the axis 1710. The second shift sleeve 1012 may be positioned about an axis 1710.

The second shift sleeve 1012 may include a valley 1822. The valley 1822 may be formed by surfaces of the second sleeve component 1022 and the shift component 924. The valley 1822 may include the second groove 930. The second shift sleeve 1012 may also include a second face 1824. The second sleeve component 1022 may include the second face 1824.

The second shift sleeve 1012 may have a plurality of fourth teeth 1832. The second shift sleeve 1012 may include a taper 1842. The fourth teeth 1832 may mesh with second engagement teeth 940 of FIGS. 9-10.

FIG. 19 shows a first graph 1900 of change in radius versus force that may be applied by a plurality spring. The first graph 1900 includes a first axis 1912 of the change in radius of the springs. The first graph 1900 includes a second axis 1914 of a reaction force that may be applied by the springs with contraction.

The first graph includes a legend 1916. The legend 1916 displays a first column 1918 of equations of traces and a second column 1920 of wire sizes. Each equation of the first column 1918 corresponds with a wire size of the second column 1920. The wire sizes of the spring include a first wire size 1922, a second wire size 1924, a third wire size 1926, a fourth wire size 1928, and a fifth wire size 1930.

The reaction force for changes in radius of the first wire size 1922 may be represented by a plot of a plurality of first data markers 1942. A first trace 1952 may be taken of the plot of first data markers 1942 via linear interpolation. An equation in the first column 1918 for the first wire size 1922 may be derived from the first trace 1952.

The reaction force for changes in radius of the second wire size 1924 may be represented by a plot of a plurality of second data markers 1944. A second trace 1954 may be taken of the plot of second data markers 1944 via linear interpolation. An equation in the first column 1918 for the second wire size 1924 may be derived from the second trace 1954.

The reaction force for changes in radius of the third wire size 1926 may be represented by a plot of a plurality of third data markers 1946. A third trace 1956 may be taken of the plot of third data markers 1946 via linear interpolation. An equation in the first column 1918 for the third wire size 1926 may be derived from the third trace 1956.

The reaction force for changes in radius of the fourth wire size 1928 may be represented by a plot of a plurality of fourth data markers 1948. A fourth trace 1958 may be taken of the plot of plurality of fourth data markers 1948 via linear interpolation. An equation in the first column 1918 for the fourth wire size 1928 may be derived from the fourth trace 1958.

The reaction force for change in radius for the fifth wire size 1930 may be represented by a plot of a plurality of fifth data markers 1950. A fifth trace 1960 may be taken of the plot of fifth data markers 1950 via linear interpolation. An equation in the first column 1918 for the fifth wire size 1930 may be derived from the fifth trace 1960.

FIG. 20 shows a thirteenth view 2000 of a sleeve 2016. The sleeve 2016 is a use-case sleeve of a different embodiment from sleeve 1216 of FIG. 12. The thirteenth view 2000 may be a side view. The sleeve 2016 be positioned about an axis 2010. The sleeve 2016 may be centered about the axis 2010, such as to be positioned radially about the axis 2010. The sleeve 2016 may have a passage 2020 that is centrally located, such that the passage 2020 may be centered about the axis 2010 when the sleeve 2016 is centered about the axis 2010. The passage 2020 may be positioned about and/or receive a shaft, such as shaft 814 of FIG. 8. The sleeve 2016 may be divided by a line 2012, e.g., line C-C. A sectional plane taken on the line 2012 is parallel with the axis 2010. A sectional plane taken on the line 2012 is collinear with the axis 2010. A sectional view that may be taken on line 2012, is shown in FIG. 8.

The sleeve 2016 includes a first structure 2030 and a second structure 2032. The first structure 2030 may be an outer structure relative and the second structure 2032 may be an inner structure relative to one another. The first structure 2030 may be positioned about the second structure 2032. The second structure 2032 may include the passage 2020. The second structure 2032 may include a socket 2018 positioned about the passage 2020.

The sleeve 2016 may have a plurality of first teeth 2040, extending in a radial direction outward from the sleeve 2016. The sleeve may also have a plurality of second teeth 2050, extending in a radial direction inward from the sleeve 2016. The first teeth 2040 may be hosted by and extend radially outward from the first structure 2030. The second teeth 2050 may be hosted by and extend radially inward from the second structure 2032. The second teeth 2050 may be complementary to a shaft, such as shaft 814, where the second teeth 2050 may physically couple the sleeve 2016 to the shaft.

The sleeve 2016 may have a groove 2042. The groove 2042 may be positioned radially between portions of the first structure 2030 and the second structure 2032. The groove 2042 may host and be positioned about at least a first wire spring 2044. The first wire spring 2044 may couple to a plurality of detent inserts 2046. The first structure 2030 may contain a plurality of openings, such as a plurality of first openings 2048 and a plurality of second openings 2052. The first and second openings 2048, 2052, may be rectangular or partially rectangular in shape. The first and second openings 2048, 2052 may be of approximately the same dimensions.

The detent inserts 2046 may be complementary to the first wire spring 2044, such as to be physically coupled to the first wire spring 2044. The detent inserts 2046 may physically couple to the wire spring via a snap fit. The detent inserts 2046 may be complementary to at least one set of openings, such that the detent inserts 2046 may be fit to and slide in a radially through the openings. As an example, the first openings 2048 may be complementary to and host the detent inserts 2046.

FIG. 21 shows a fourteenth view 2100 of a sleeve 2016. The fourteenth view 2100 is a sectional view taken on line 2012 of FIG. 20. The fourteenth view 2100 shows a shift sleeve 2120 positioned about the sleeve 2016. The sleeve 2016 may be sandwiched between a first engagement component 2122 and a second engagement component 2124. The shift sleeve 2120 may be positioned radially about the sleeve 2016, and the sleeve 2016 may be positioned radially about portions of the first engagement component 2122 and second engagement component 2124. There may be a gap 2126 between the first engagement component 2122 and the second engagement component 2124. Portion of the second structure 2032 may extend through and be fit to the gap 2126, such that the second structure 2032 may rotate about an axis, such as axis 2010 of FIG. 20.

The shift sleeve 2120 may include a groove 2132. The groove 2132 may curve radially about an axis with the shift sleeve 2120. The groove 2132 may depress in a radially inward direction into the material of the shift sleeve 2120. The shift sleeve 2120 may have a plurality of third teeth 2134. The third teeth 2134 may extend in a radially inward direction from the shift sleeve 2120. A tooth 2136 of each of the detent inserts 2046 may fit to the shift sleeve 2120, such that the tooth 2136 may prevent the sliding of the shift sleeve 2120 without a deliberate force above a threshold of force.

The first engagement component 2122 may include a first wall 2142 and a first sleeve component 2144. The first engagement component 2122 may have a plurality of fourth teeth 2146 and a plurality of fifth teeth 2148. The fourth teeth 2146 may extend radially outward from the first engagement component 2122. The plurality of fifth teeth 2148 may extend radially inward from the first engagement component 2122. The fourth teeth 2146 may be hosted on the first wall 2142. The fourth teeth 2146 may mesh with the third teeth 2134.

The second engagement component 2124 may include a second wall 2152 and a second sleeve component 2154. The second engagement component 2124 may have a plurality of sixth teeth 2156 and a plurality of seventh teeth 2158. The sixth teeth 2156 may extend radially outward from the second engagement component 2124. The sixth teeth 2156 may extend radially inward from the second engagement component 2124. The sixth teeth 2156 may be hosted on the second wall 2152. The sixth teeth 2156 may mesh with the third teeth 2134.

Each of the first openings 2048 may be flanked by a first wall 2162 and a second wall 2166. The first wall 2162 may be contiguous with a first base 2164. The second wall 2166 may be contiguous with a second base 2168. Each of the detent inserts 2046 may be sandwiched between the first wall 2162 and the second wall 2166. The first wall 2162 may have a first step 2170. The first wall 2162 may be contiguous with the first base 2164 via the first step 2170. The second wall 2166 may have a second step 2172. The second wall 2166 may be contiguous with the second base 2168 via the second step 2172. A plurality of sixth teeth 2174 may extend radially outward from the first wall 2162. A plurality of seventh teeth 2176 may extend radially outward from the second wall 2166. The sixth teeth 2174 and seventh teeth 2176 may mesh with the third teeth 2134.

The first structure 2030 may host a second wire spring 2178. The second wire spring 2178 may be complementary to the detent inserts 2046. The first and second wire springs 2044, 2178 are visible from the first openings 2048.

The gap 2126 may have a clearance 2182. The clearance 2182 may be of a distance such that a land 2180 may be positioned in and extend through the gap 2126, such that the land 2180 may not abut or make surface sharing contact with either the first engagement component 2122 or the second engagement component 2124.

FIG. 22 show shows a fifteenth view 2200 of a sleeve 2016. The fifteenth view 2200 is a sectional view taken on line 718 of FIG. 7. The fifteenth view 2200 shows a sectional view of an electric drive axle 810, a housing 2210, a first screw assembly 2212, and a plurality of components coupled with the first screw assembly 2212. A lever 2214 and an actuator 2216 may couple to the first screw assembly 2212. The lever 2214 may include coupling and actuator components described above, such as the first coupling component 936 and first actuator component 938 of FIG. 9. The first screw assembly 2212 may be housed in a cavity 2222 of the housing 2210. The first screw assembly 2212 may be a ball screw assembly.

The first screw assembly 2212 may include a screw 2224 and a sleeve 2228. The screw 2224 may be physically coupled to the actuator 2216, such that the actuator 2216 may actuate the screw 2224 in a direction parallel with the second axis 710. The sleeve 2228 may be positioned about the screw 2224. The sleeve 2228 may couple to a screw 2224, such that the sleeve may advance with the sleeve 2228. The screw 2224 may be a lead screw. A coupling 2226 may be positioned about the sleeve 2228. The coupling 2226 may be fastened to the sleeve 2228 via a fastener 2230, such as a pin. The lever 2214 may include or physically couple to the coupling 2226. A first bearing 2232 and a second bearing 2234 may be positioned about and support the screw 2224.

The lever 2214 may physically couple to the second shift sleeve 1012 via a shift collar 2242. Lever 2214 may be shifted and the screw 2224 may advance in a first direction 2252 and a second direction 2254. The first direction 2252 may be opposite the second direction 2254. The first and second directions 2252, 2254 may be parallel with the second axis 710.

FIG. 23 shows a sixteenth view 2300 of a lever 2310, a second screw assembly 2312, and a shift sleeve 2318. The sixteenth view 2300 shows a first axis 2306, where the first axis 2306 is a longitudinal axis for the shift sleeve 2318. The sixteenth view 2300 shows a second axis 2308 where the second axis is a longitudinal axis for the second screw assembly 2312.

The second screw assembly 2312 may be a ball screw assembly. The second screw assembly 2312 may be a may be off axis screw assembly, where the direction of actuation for the lever 2310 and the components of the second screw assembly 2312 are not on parallel axes. For example, the first axis 2306 and the second axis 2308 may not be parallel. The shift sleeve 2318 may be shifted in directions parallel with the first axis 2306. Components of the second screw assembly 2312 may be shifted in directions parallel to the second axis 2308. The lever 2310 and its components may be shifted along an axis that is not parallel with the first axis 2306. The second screw assembly 2312 may include a screw 2324 and a sleeve 2328.

The lever 2310 may include a first lever component 2314 and a second lever component 2320. The first lever component 2314 and second lever component 2320 may each be lever arms that may be pivotably coupled at a joint 2322. The second screw assembly 2312 includes a screw 2324 and a sleeve 2328. The sleeve 2328 may be positioned about the screw 2324. The screw 2324 may be coupled to the actuator 2316, such that the actuator 2316 actuate the screw 2324 in a direction. When actuated, the screw 2324 may rotate and advanced in a direction, such as rotating about the second axis 2308 and advancing in direction parallel with the second axis 2308. The sleeve 2328 may be driven in a direction by the actuation of the screw 2324. The first lever component 2314 may couple to the sleeve 2328. The second lever component 2320 may couple to the shift sleeve 2318.

The first lever component 2314 may couple to the sleeve 2328 via a first coupling 2326. The second lever component 2320 may couple to the shift sleeve 2318 via a second coupling 2344 and a shift collar 2342.

FIG. 24 shows a seventeenth view 2400 of the second gear set 824, third gear set 826, and a third clutch assembly 2422. The seventeenth view 2400 is a sectional view. The third clutch assembly 2422 may be a clutch assembly of a different embodiment from the first clutch assembly 828 and second clutch assembly 1008 of FIG. 8 and FIG. 10, respectively. The seventeenth view 2400 shows an axis 2410. Axis 2410 may be a longitudinal axis and may be parallel with the second axis 710 of FIG. 7.

The second gear set 824 may include a fourth carrier 2432. The fourth carrier 2432 may be a planetary carrier and may support the first planet gears 856 of FIG. 8. The third gear set 826 may include a fifth carrier 2434. The fifth carrier 2434 may be a planetary carrier and may support the second planet gears 864 of FIG. 8. The third gear set 826 may include a third sun gear 2436. The third sun gear 2436 is of a different embodiment than the second sun gear 866 of FIG. 8. The third sun gear 2436 may include or physically couple to a first appendage 2446 and a second appendage 2448.

The third clutch assembly 2422 includes a third shift sleeve 2442, an engaging component 2444, a first engagement component 2452, and a second engagement component 2454. The third shift sleeve 2442 may physically couple to the engaging component 2444. The second appendage 2448 may include or physically couple to the first engagement component 2452. The fifth carrier 2434 may include or physically couple to the second engagement component 2454. The engaging component 2444 may selectively couple to, e.g. engage with, the first engagement component 2452 when actuated in a first direction. The engaging component 2444 may selectively couple to the second engagement component 2454 when actuated in a second direction opposite to the first direction. The first direction and the second direction may be parallel with the axis 2410.

The third shift sleeve 2442 may have a groove 2456. The coupling component 936 may be fit to the groove 2456. When fit to the groove 2456, third shift sleeve 2442 may be translated by and shifted with the coupling component 936.

The third shift sleeve 2442 may be supported and guided by features of the fourth carrier 2432, therein the third shift sleeve 2442 may be a carrier piloted shift sleeve. The third shift sleeve 2442 may extend through, be supported by, and be guided by a passage 2458 of the fourth carrier 2432. A portion of the third shift sleeve 2442 that may be housed by the passage 2458 and may include a first groove 2462, a second groove 2464, and a third groove 2466. The fourth carrier 2432 may house a fourth detent insert 2472. The fourth detent insert 2472 may be complementary to the first groove 2462, the second groove 2464, and the third groove 2466, such as to have components fit to the first groove 2462, the second groove 2464, and the third groove 2466.

When engaged with the first engagement component 2452, the engaging component 2444 may rotationally couple to the second appendage 2448 and the third sun gear 2436. The fourth carrier 2432 may rotationally couple to the third sun gear 2436 via the third shift sleeve 2442 and the engaging component 2444. When rotationally coupling the fourth carrier 2432 to the third sun gear 2436, the third clutch assembly 2422 may engage the second gear set 824 and the third gear set 826 to rotationally couple and enable a lower range mode. The fourth detent insert 2472 may fit to the third groove 2466 when the engaging component 2444 is engaged with the first engagement component 2452.

When engaged with the second engagement component 2454, the engaging component 2444 may rotationally couple to the fifth carrier 2434. The fourth carrier 2432 may rotationally couple to the fifth carrier 2434 via the third shift sleeve 2442 and the engaging component 2444. When rotationally coupling the fourth carrier 2432 to the fifth carrier 2434, the third clutch assembly 2422 may engage the second gear set 824 and the third gear set 826 to rotationally couple and enable a higher range mode. The fourth detent insert 2472 may fit to the first groove 2462 when the engaging component 2444 is engaged with the second engagement component 2454.

When the third shift sleeve 2442 and engaging component are positioned to rotationally couple neither the third sun gear 2436 nor the fifth carrier 2434, the third clutch assembly 2422 may be engaged to enable a neutral mode between the second gear set 824 and the third gear set 826. The fourth detent insert 2472 may fit to the second groove 2464 when the engaging component 2444 is engaged with neither the first engagement component 2452 nor the second engagement component 2454.

FIG. 25 shows an eighteenth view 2500 of the second gear set 824, third gear set 826, and a fourth clutch assembly 2522. The eighteenth view 2500 is a sectional view. The fourth clutch assembly 2522 may be a clutch assembly of a different embodiment from the first clutch assembly 828, second clutch assembly 1008, and the third clutch assembly 2422 of FIG. 8, FIG. 10, and FIG. 24, respectively.

The second gear set 824 may include a sixth carrier 2532. The sixth carrier 2532 may be a planetary carrier and may support the first planet gears 856 of FIG. 8.

The fourth clutch assembly 2522 includes a fourth shift sleeve 2542, the engaging component 2444, the first engagement component 2452, and the second engagement component 2454.

The fourth shift sleeve 2542 may be supported and guided by features of the sixth carrier 2532. The fourth shift sleeve 2542 may therein be a carrier piloted shift sleeve. The fourth shift sleeve 2542 may extend through, be supported by, and be guided by a passage 2558 of the sixth carrier 2532. A portion of the fourth shift sleeve 2542 may be housed by the passage 2558. The fourth carrier 2432 may have a detent carrier 2574, where the fourth carrier 2432 may include or physically couple to the detent carrier 2574. The detent carrier 2574 may house fifth detent insert 2572. The fourth shift sleeve 2542 may include a first groove 2562, a second groove 2564, and a third groove 2566. The fifth detent insert 2572 may be complementary to the first groove 2562, the second groove 2564, and the third groove 2566, such as to have components fit to the first groove 2562, the second groove 2564, and the third groove 2566.

The fifth detent insert 2572 may fit to the third groove 2566 when the engaging component 2444 is engaged with the first engagement component 2452.

The fifth detent insert 2572 may fit to the first groove 2562 when the engaging component 2444 is engaged with the second engagement component 2454.

The fifth detent insert 2572 may fit to the second groove 2564 when the engaging component 2444 is engaged with neither the first engagement component 2452 nor the second engagement component 2454.

FIG. 26 shows a nineteenth view 2600 of the second gear set 824, third gear set 826, and the third clutch assembly 2422, a barrel cam assembly 2610, and a lever 2614. The nineteenth view 2600 is a sectional view.

The lever 2614 may couple to the third shift sleeve 2442 via the groove 2456. The lever 2614 may include the coupling component 936 and actuator component 938 of FIG. 9.

The lever 2614 may include a first lever component 2624 and a second lever component 2626. The first lever component 2314 and the second lever component 2626 may each be lever arms that may be pivotably coupled at a joint 2622.

The barrel cam assembly 2610 includes a shaft 2632 and a barrel cam 2634. The barrel cam 2634 is rotationally coupled to the shaft 2632, such that the barrel cam 2634 may rotate in the same direction as the shaft 2632. The barrel cam 2634 may include a patterned groove 2638. The lever 2614 may include a bearing component 2636, such as a dowel. The bearing component 2636 may be fit to the patterned groove 2638, such that the bearing component 2636 may rotate within and be shifted by the patterned groove 2638.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

The technical effect of the electric drive axles and operating methods described herein is to expand the gearbox's functionality and increase the axle's capability with regard to operating range and driving environment, correspondingly.

FIG. 1-4B shows schematics of an example configuration with relative positioning of the various components. FIGS. 7-18 show example configurations with approximate position. FIGS. 7-18 are shown approximately to scale; though other relative dimensions may be used. As used herein, the terms “approximately” is construed to mean plus or minus five percent of the range unless otherwise specified.

Further, FIGS. 1-4B and FIGS. 7-18 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The disclosure also provides support for an electric drive axle of a vehicle, comprising: an electric machine rotationally coupled to a gearbox, the gearbox comprising: a higher range planetary gear set coupled to a lower range planetary gear set via a clutch, and an output gear designed to receive rotational input from at least one of the higher range planetary gear set and the lower range planetary gear set, wherein the clutch is configured to: in a lower range position, direct mechanical power through the higher range planetary gear set and the lower range planetary gear set, and in a higher range position, direct mechanical power to the higher range planetary gear set which bypasses the lower range planetary gear set. In a first example of the system, the higher and lower range planetary gear sets are arranged coaxially with the electric machine. In a second example of the system, optionally including the first example, the higher range planetary gear set is positioned axially between the lower range planetary gear set and the output gear. In a third example of the system, optionally including one or both of the first and second examples, an axle shaft of the electric drive axle is coupled to a differential of the vehicle, and a first axis of rotation of the differential is offset from a second axis of rotation of the gearbox, such that the axle shaft extends along a lateral side of the electric machine. In a fourth example of the system, optionally including one or more or each of the first through third examples, one or both of the higher range planetary gear set and the lower range planetary gear set are simple planetary gear sets. In a fifth example of the system, optionally including one or more or each of the first through fourth examples, a first carrier of the lower range planetary gear set further comprises: a first sleeve including a cavity housing a portion of detent inserts, each detent insert having a tooth, a first shift sleeve including: a sleeve component having a plurality of first engaging teeth that engage with complimentary features of a first engaging component, and a plurality of second engaging teeth that engage with complimentary features of a second engaging component, a shift component, and a plurality of grooves, wherein an engagement of a tooth of a detent insert with a groove of the plurality of grooves prevents a movement of the first shift sleeve without a deliberate force above a threshold force, and in a first condition where the tooth is mated to a first groove of the plurality of grooves, the clutch is engaged in a first way, where the sleeve component selectively couples the second engaging component, enabling a lower range mode of the gearbox, in a second condition where the tooth is mated to a second groove of the plurality of grooves, the clutch is engaged in a second way, where the sleeve component does not selectively couple to either of the first engaging component or the second engaging component, enabling a neutral mode of the gearbox, and in a third condition where the tooth is mated to a third groove of the plurality of grooves, the clutch is engaged in a third way where the sleeve component selectively couples the first engaging component, enabling a higher range mode of the gearbox. In a sixth example of the system, optionally including one or more or each of the first through fifth examples, a second carrier of the higher range planetary gear set is coupled to the output gear.

The disclosure also provides support for a gearbox rotationally coupled to an electric machine of an electric drive axle of a vehicle, the gearbox comprising a higher range planetary gear set coupled to a lower range planetary gear set via a clutch, wherein the clutch is configured to: selectively rotationally couple an input gear of the gearbox to a sun gear in each of the higher range planetary gear set and the lower range planetary gear set in different positions, or selectively rotationally couple a carrier in the higher range planetary gear set to a carrier and a sun gear in the lower range planetary gear set in different positions. In a first example of the system, the electric machine is directly coupled to the gearbox and is coaxial to the higher range planetary gear set and the lower range planetary gear set. In a second example of the system, optionally including the first example, an output gear of the gearbox is directly coupled to a differential. In a third example of the system, optionally including one or both of the first and second examples, the system further comprises: a controller including instructions stored in memory that when executed by a processor, cause the processor to: during a first operating condition, operate the gearbox in a higher range mode where mechanical power from the electric machine flows through the lower range planetary gear set and the higher range planetary gear set in series, and during a second operating condition, operate the gearbox in a lower range mode where mechanical power from the electric machine bypasses the lower range planetary gear set and travels to the higher range planetary gear set. In a fourth example of the system, optionally including one or more or each of the first through third examples, the clutch is operated to transition the gearbox between the higher range mode and the lower range mode in response to an operator-induced mode selection adjustment command. In a fifth example of the system, optionally including one or more or each of the first through fourth examples, the clutch rotationally couples an input gear of the gearbox to a first sun gear of the lower range planetary gear set in the lower range mode, and rotationally couples the input gear to a second sun gear of the higher range planetary gear set in the higher range mode. In a sixth example of the system, optionally including one or more or each of the first through fifth examples, the clutch rotationally couples a first carrier in the lower range planetary gear set to a second carrier in the higher range planetary gear set in the lower range mode, and rotationally couples the second carrier in the higher range planetary gear set to the first sun gear of the lower range planetary gear set in the higher range mode. In a seventh example of the system, optionally including one or more or each of the first through sixth examples, the electric drive axle further comprises a controller including instructions stored in memory executable by a processor that during a first operating condition cause the controller to: operate the gearbox in the higher range mode to flow mechanical power from the electric machine through the lower range planetary gear set and the higher range planetary gear set in series, and operate the gearbox in the lower range mode where mechanical power from the electric machine bypasses the lower range planetary gear set and travels to the higher range planetary gear set. In a eighth example of the system, optionally including one or more or each of the first through seventh examples, the higher and lower range planetary gear sets are simple planetary gear sets.

The disclosure also provides support for a method for operating an electric drive axle, the method comprising: operating a clutch coupled to a gearbox of the electric drive axle to transition the gearbox between a higher range mode and a lower range mode, wherein the electric drive axle comprises a higher range planetary gear set selectively coupled to a lower range planetary gear set in series via the clutch, and wherein in the higher range mode, mechanical power from an electric machine bypasses the lower range planetary gear set, and in the lower range mode, mechanical power from the electric machine travels through the lower range planetary gear set and the higher range planetary gear set. In a first example of the method, a carrier of the lower range planetary gear set includes: a first sleeve including a cavity housing a portion of detent inserts, each detent insert having a tooth, a first shift sleeve including: a sleeve component having a plurality of first engaging teeth that engage with complimentary features of a first engaging component, and a plurality of second engaging teeth that engage with complimentary features of a second engaging component, a shift component, and a plurality of grooves, wherein an engagement of a tooth of a detent insert with a groove of the plurality of grooves prevents a movement of the first shift sleeve without a deliberate force above a threshold force. In a second example of the method, optionally including the first example, the method further comprises: in response to the clutch being engaged in a first way, where the tooth is mated to a first groove of the plurality of grooves, selectively coupling the sleeve component to the second engaging component enabling the lower range mode of the gearbox, in response to the clutch being engaged in a second way, where the tooth is mated to a second groove of the plurality of grooves, not coupling the sleeve component to either of the first engaging component or the second engaging component, enabling a neutral mode of the gearbox, and in response to the clutch being engaged in a second way, where the tooth is mated to a third groove of the plurality of grooves, selectively coupling the sleeve component to the first engaging component, enabling the higher range mode of the gearbox. In a third example of the method, optionally including one or both of the first and second examples, the higher and lower range planetary gear sets are arranged coaxially with the electric machine, and the higher range planetary gear set is positioned axially between the lower range planetary gear set and an output gear of the gearbox.

In another representation, a range selectable gearbox in an all-electric drive system is provided that comprises a range selector clutch that operates in higher range configuration where the clutch transfers power to a higher range planetary gear set which bypasses a lower range planetary gear set and a lower range configuration where the clutch transfers power to the lower range planetary gear set and the higher range planetary gear set in series.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other vehicle hardware. The specific routines described herein may represent one or more of multiple processing strategies. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle control system, where the described actions are carried out by executing the instructions in a system including the various hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines. The subject matter of the present disclosure includes all novel and non-obvious combinations and sub-combinations of the various systems and configurations, and other features, functions, and/or properties disclosed herein. While various embodiments have been described above, it should be understood that they have been presented by way of example, and not limitation. The embodiments described above are therefore to be considered in all respects as illustrative, not restrictive.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric drive axle of a vehicle, comprising:
an electric machine rotationally coupled to a gearbox, the gearbox comprising:
a higher range planetary gear set coupled to a lower range planetary gear set via a clutch; and
an output gear designed to receive rotational input from at least one of the higher range planetary gear set and the lower range planetary gear set;
wherein the clutch is configured to:
in a lower range position, direct mechanical power through the higher range planetary gear set and the lower range planetary gear set; and
in a higher range position, direct mechanical power to the higher range planetary gear set which bypasses the lower range planetary gear set.

2. The electric drive axle of claim 1, wherein the higher and lower range planetary gear sets are arranged coaxially with the electric machine.

3. The electric drive axle of claim 1, wherein the higher range planetary gear set is positioned axially between the lower range planetary gear set and the output gear.

4. The electric drive axle of claim 1, wherein an axle shaft of the electric drive axle is coupled to a differential of the vehicle, and a first axis of rotation of the differential is offset from a second axis of rotation of the gearbox, such that the axle shaft extends along a lateral side of the electric machine.

5. The electric drive axle of claim 1, wherein one or both of the higher range planetary gear set and the lower range planetary gear set are simple planetary gear sets.

6. The electric drive axle of claim 1, wherein a first carrier of the lower range planetary gear set further comprises:
a first sleeve including a cavity housing a portion of detent inserts, each detent insert having a tooth;
a first shift sleeve including:
a sleeve component having a plurality of first engaging teeth that engage with complimentary features of a first engaging component, and a plurality of second engaging teeth that engage with complimentary features of a second engaging component;
a shift component; and
a plurality of grooves;
wherein an engagement of a tooth of a detent insert with a groove of the plurality of grooves prevents a movement of the first shift sleeve without a deliberate force above a threshold force; and
in a first condition where the tooth is mated to a first groove of the plurality of grooves, the clutch is engaged in a first way, where the sleeve component selectively couples the second engaging component, enabling a lower range mode of the gearbox;
in a second condition where the tooth is mated to a second groove of the plurality of grooves, the clutch is engaged in a second way, where the sleeve component does not selectively couple to either of the first engaging component or the second engaging component, enabling a neutral mode of the gearbox; and
in a third condition where the tooth is mated to a third groove of the plurality of grooves, the clutch is engaged in a third way where the sleeve component selectively couples the first engaging component, enabling a higher range mode of the gearbox.

7. The electric drive axle of claim 1, wherein a second carrier of the higher range planetary gear set is coupled to the output gear.

8. A gearbox rotationally coupled to an electric machine of an electric drive axle of a vehicle, the gearbox comprising a higher range planetary gear set coupled to a lower range planetary gear set via a clutch;
wherein the clutch is configured to:
selectively rotationally couple an input gear of the gearbox to a sun gear in each of the higher range planetary gear set and the lower range planetary gear set in different positions; or
selectively rotationally couple a carrier in the higher range planetary gear set to a carrier and a sun gear in the lower range planetary gear set in different positions.

9. The gearbox of claim 8, wherein the electric machine is directly coupled to the gearbox and is coaxial to the higher range planetary gear set and the lower range planetary gear set.

10. The gearbox of claim 8, wherein an output gear of the gearbox is directly coupled to a differential.

11. The gearbox of claim 8, further comprising a controller including instructions stored in memory that when executed by a processor, cause the processor to:
during a first operating condition, operate the gearbox in a higher range mode where mechanical power from the electric machine flows through the lower range planetary gear set and the higher range planetary gear set in series; and
during a second operating condition, operate the gearbox in a lower range mode where mechanical power from the electric machine bypasses the lower range planetary gear set and travels to the higher range planetary gear set.

12. The gearbox of claim 11, wherein the clutch is operated to transition the gearbox between the higher range mode and the lower range mode in response to an operator-induced mode selection adjustment command.

13. The gearbox of claim 11, wherein the clutch rotationally couples an input gear of the gearbox to a first sun gear of the lower range planetary gear set in the lower range mode, and rotationally couples the input gear to a second sun gear of the higher range planetary gear set in the higher range mode.

14. The gearbox of claim 13, wherein the clutch rotationally couples a first carrier in the lower range planetary gear set to a second carrier in the higher range planetary gear set in the lower range mode, and rotationally couples the second carrier in the higher range planetary gear set to the first sun gear of the lower range planetary gear set in the higher range mode.

15. The gearbox of claim 11, wherein the electric drive axle further comprises a controller including instructions stored in memory executable by a processor that during a first operating condition cause the controller to:
operate the gearbox in the higher range mode to flow mechanical power from the electric machine through the lower range planetary gear set and the higher range planetary gear set in series; and
operate the gearbox in the lower range mode where mechanical power from the electric machine bypasses the lower range planetary gear set and travels to the higher range planetary gear set

16. The gearbox of claim 8, wherein the higher and lower range planetary gear sets are simple planetary gear sets.

17. A method for operating an electric drive axle, the method comprising:
operating a clutch coupled to a gearbox of the electric drive axle to transition the gearbox between a higher range mode and a lower range mode;
wherein the electric drive axle comprises a higher range planetary gear set selectively coupled to a lower range planetary gear set in series via the clutch; and
wherein in the higher range mode, mechanical power from an electric machine bypasses the lower range planetary gear set, and in the lower range mode, mechanical power from the electric machine travels through the lower range planetary gear set and the higher range planetary gear set.

18. The method of claim 17, wherein a carrier of the lower range planetary gear set includes:
a first sleeve including a cavity housing a portion of detent inserts, each detent insert having a tooth;
a first shift sleeve including:
a sleeve component having a plurality of first engaging teeth that engage with complimentary features of a first engaging component, and a plurality of second engaging teeth that engage with complimentary features of a second engaging component;
a shift component; and
a plurality of grooves;
wherein an engagement of a tooth of a detent insert with a groove of the plurality of grooves prevents a movement of the first shift sleeve without a deliberate force above a threshold force.

19. The method of claim 18, further comprising:
in response to the clutch being engaged in a first way, where the tooth is mated to a first groove of the plurality of grooves, selectively coupling the sleeve component to the second engaging component enabling the lower range mode of the gearbox;
in response to the clutch being engaged in a second way, where the tooth is mated to a second groove of the plurality of grooves, not coupling the sleeve component to either of the first engaging component or the second engaging component, enabling a neutral mode of the gearbox; and
in response to the clutch being engaged in a second way, where the tooth is mated to a third groove of the plurality of grooves, selectively coupling the sleeve component to the first engaging component, enabling the higher range mode of the gearbox.

20. The method of claim 17, wherein the higher and lower range planetary gear sets are arranged coaxially with the electric machine, and the higher range planetary gear set is positioned axially between the lower range planetary gear set and an output gear of the gearbox.
